(19) United States
(12) Patent Application Publication
(10) Pub. No.: US 2025/0112781 A1
(43) Pub. Date: Apr. 3, 2025

(54) MULTI-SCHEME HASH-BASED DIGITAL SIGNATURE VERIFICATION PROCESSORS, METHODS, AND SYSTEMS

(71) Applicant: INTEL CORPORATION, SANTA CLARA, CA (US)

(72) Inventors: Santosh GHOSH, Hillsboro, OR (US); Manoj SASTRY, Portland, OR (US)

(21) Appl. No.: 18/375,317

(22) Filed: Sep. 29, 2023

(51) Int. Cl. H04L 9/32

(52) U.S. Cl. CPC H04L 9/3247

(57) ABSTRACT

A digital signature verification unit or other apparatus of an aspect includes cryptographic hash circuitry to generate cryptographic hashes and multi-scheme hash-based digital signature verification circuitry coupled with the cryptographic hash circuitry. The multi-scheme hash-based digital signature verification circuitry is to use the cryptographic hash circuitry to verify digital signatures according to only one of a plurality of hash-based digital signature verification schemes at a time, the plurality of hash-based digital signature verification schemes including a first hash-based digital signature verification scheme and a second hash-based digital signature verification scheme. Other apparatus, methods, and systems are disclosed.

### BACKGROUND

### Technical Field

Embodiments described herein generally relate to data processing. In particular, embodiments described herein generally relate to digital signature verification.

### Background Information

Digital signatures are widely used in different environments to authenticate data (e.g., emails, messages, electronic documents, transaction data, personal information, software, firmware, data files, and other types of data). When implemented properly, digital signatures give the receiver of the data an assurance or reason to believe that the data is authentic and was sent by a sender known to the recipient. Various mathematical or cryptographic schemes to generate and verify digital signatures have been developed.

### BRIEF DESCRIPTION OF THE DRAWINGS

Various examples in accordance with the present disclosure will be described with reference to the drawings, in which:

FIG. 1 is a block diagram of a network suitable for implementing embodiments that includes a first electronic device and a second electronic device that exchange a message and a digital signature corresponding to the message.

FIG. 2 is a block diagram of a network suitable for implementing embodiments that includes a server and a computer system that exchange software/firmware and a digital signature corresponding to the software/firmware.

FIG. 3 is a block diagram of an embodiment of a digital signature verification unit.

FIG. 4 is a block diagram of an embodiment of a digital signature verification unit that includes a shared memory.

FIG. 5 is a block diagram of a detailed example embodiment of a digital signature verification unit.

FIG. 6 is a block diagram illustrating that in some embodiments a shared memory may alternatingly be used to store data structures for either a first or second hash-based digital signature verification scheme.

FIG. 7 illustrates a specific example embodiment of a suitable data structure for an XMSS based digital signature verification scheme.

FIG. 8 illustrates a specific example embodiment of a suitable data structure for an LMS based digital signature verification scheme.

FIG. 9 illustrates an example computing system.

FIG. 10 illustrates a block diagram of an example processor and/or System on a Chip (SoC) that may have one or more cores and an integrated memory controller.

FIG. 11(A) is a block diagram illustrating both an example in-order pipeline and an example register renaming, out-of-order issue/execution pipeline according to examples.

FIG. 11(B) is a block diagram illustrating both an example in-order architecture core and an example register renaming, out-of-order issue/execution architecture core to be included in a processor according to examples.

FIG. 12 illustrates examples of execution unit(s) circuitry.

FIG. 13 is a block diagram of a register architecture according to some examples.

FIG. 14 illustrates examples of an instruction format.

FIG. 15 illustrates examples of an addressing information field.

FIG. 16 illustrates examples of a first prefix.

FIGS. 17(A)-(D) illustrate examples of how the R, X, and B fields of the first prefix in FIG. 16 are used.

FIGS. 18(A)-(B) illustrate examples of a second prefix.

FIG. 19 illustrates examples of a third prefix.

FIG. 20 is a block diagram illustrating the use of a software instruction converter to convert binary instructions in a source instruction set architecture to binary instructions in a target instruction set architecture according to examples.

### DETAILED DESCRIPTION OF EMBODIMENTS

The present disclosure relates to circuitry, apparatus, methods, and systems to verify digital signatures. In the following description, numerous specific details are set forth (e.g., specific algorithms or schemes, sequences of operations, data formats, processor configurations, microarchitectural details, etc.). However, embodiments may be practiced without these specific details. In other instances, well-known circuits, structures and techniques have not been shown in detail to avoid obscuring the understanding of the description.

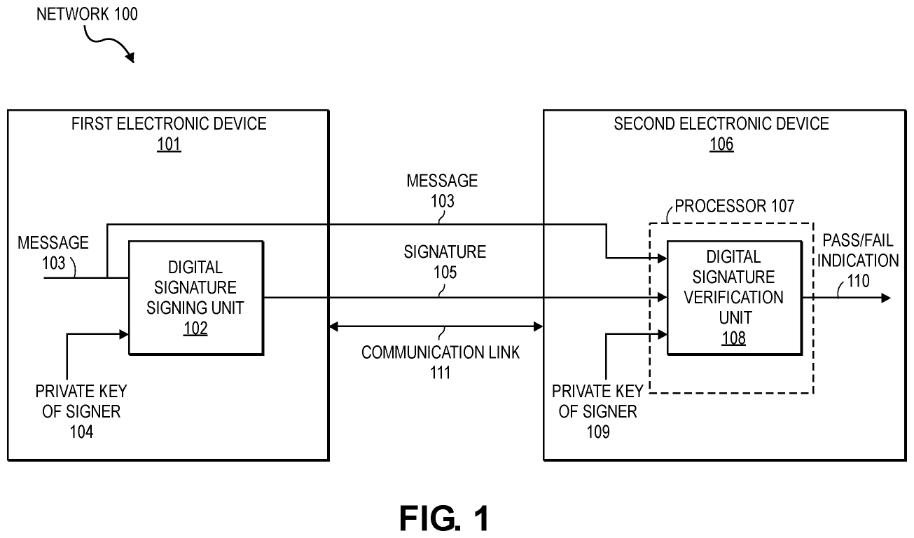

FIG. 1 is a block diagram of a network 100 suitable for implementing embodiments that includes a first electronic device 101 and a second electronic device 106 that exchange a message 103 and a digital signature 105 corresponding to the message. By way of example, the first and second electronic devices may be computer systems (e.g., servers, workstations, desktops, laptops, smart phones), network equipment (e.g., routers, switches), diverse types of receivers and transmitters, or other types of electronic devices. The first electronic device and the second electronic device are coupled by at least one wired or wireless communication link 111 (e.g., the Internet or any of a wide various other types of communication links used to allow electronic devices to communicate).

The first electronic device includes a digital signature signing unit 102. The digital signature signing unit may receive as inputs a message 103 (e.g., any of the previously described types of data) and a private key 104 of the signer (e.g., that is private to the digital signature signing unit and/or the first electronic device). The digital signature signing unit uses a digital signature scheme (e.g., a Leighton-Micali Signatures (LMS) based scheme, an extended Merkle Signature Scheme (XMSS) based scheme, or another type of hash-based digital signature scheme) to sign the message 103 to generate a corresponding signature 105. Both the message and the signature are sent from the first electronic device to the second electronic device via the communication link.

The second electronic device includes a digital signature verification unit 108. In some cases, the digital signature verification unit may optionally be part of a central processing unit (CPU), security processor or co-processor, network processor or co-processor, or other type of processor 107 of the second electronic device. The digital signature verification unit may receive as inputs the message 103, the signature 105, and a public key 109 of the signer. By way of example, the first electronic device may use a key-generation algorithm suitable for the digital signature scheme to produce both the private key 104 and the public key 109, and then the first electronic device may publish, share, or otherwise provide the public key to the second electronic device. The digital signature verification unit may use the same digital signature scheme (e.g., an LMS based scheme, an XMSS based scheme, or another type of hash-based digital signature scheme), which was used by the digital signature signing unit, to verify or authenticate the message using the public key.

Such verification may broadly represent a test of whether the received message and the received signature are valid. For example, this may represent a cryptographic test of whether the received message, the received signature, and the public key are all cryptographically consistent with one another according to the digital signature scheme. Representatively, the digital signature verification unit may generate a signature using the received message and the public key and compare the generated signature with the received signature. If the received message (or the received signature) had been changed (e.g., tampered with) after the original signature was generated from the message by the first electronic device, then the authentication or verification may fail. Otherwise, if the received message, the received signature, and the public key are all cryptographically consistent with one another according to the digital signature scheme (e.g., the two signatures match), then the message may be verified or authenticated. The digital signature verification unit may output a pass and/or fail indication 110 (e.g., a signal or value having at least a first value, signal level, or the like to represent pass and a second value, signal level, or the like to represent fail).

Such digital signatures are used in a wide variety of different environments to ensure that data being conveyed from one entity to another party has not been changed and is valid. As one more specific illustrative example, software and/or firmware are often transmitted to and installed on deployed computer systems (e.g., as patches or updates), and it is often desirable to verify or authenticate the software and/or firmware to ensure it is genuine prior to installing it on the deployed computer systems (e.g., for security reasons to avoid corrupted software and/or firmware being installed on the computer system).

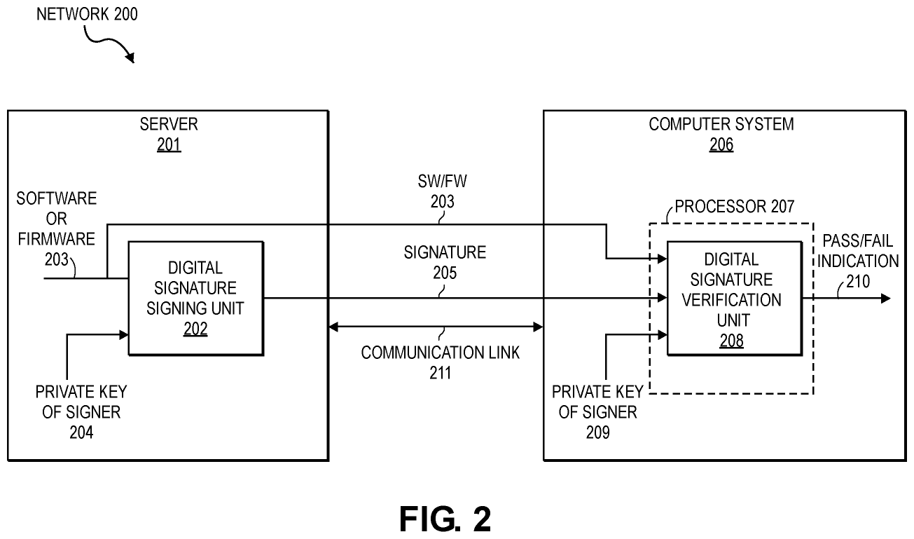

FIG. 2 is a block diagram of a network 200 suitable for implementing embodiments that includes a server 201 and a computer system 206 (e.g., a workstation, desktop, laptop, smart phone, etc.) that exchange software (SW) and/or firmware (FW), and a digital signature 205 corresponding to the SW/FW. The SW/FW broadly represents a message or data. The server and the computer system are coupled by at least one wired or wireless communication link 211 (e.g., the Internet). The server includes a digital signature signing unit 202. The digital signature signing unit uses a digital signature scheme (e.g., an LMS based scheme, an XMSS based scheme, or another type of hash-based digital signature scheme) to sign the SW/FW 203 to generate a signature 205. Both the SW/FW and the signature are sent from the server to the computer system via the communication link. The computer system includes a digital signature verification unit 208. In some cases, the digital signature verification unit may optionally be part of a CPU, security processor, network processor, or other type of processor 207. The digital signature verification unit may use the same digital signature scheme (e.g., an LMS based scheme, an XMSS based scheme, or another type of hash-based digital signature scheme) to verify or authenticate the SW/FW and the received signature using a public key 209. This may be done as previously described. The digital signature verification unit may output a pass and/or fail indication 210.

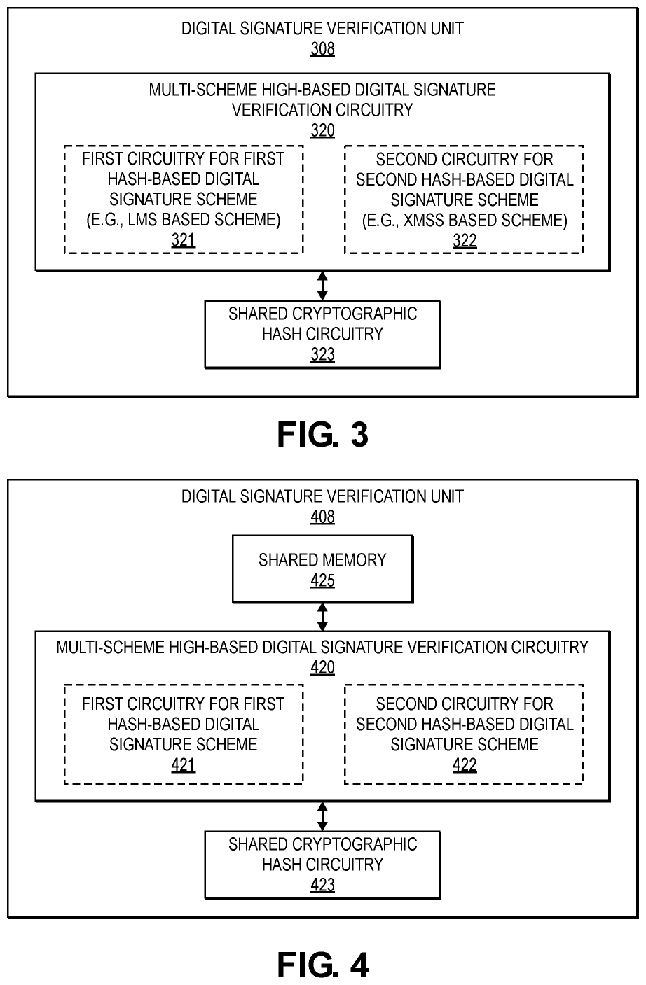

FIG. 3 is a block diagram of an embodiment of a digital signature verification unit 308. In some embodiments, the digital signature verification unit may be used for the digital signature verification unit 108 of FIG. 1 and/or for the digital signature verification unit 208 of FIG. 2.

The digital signature verification unit includes shared cryptographic hash circuitry 323 to generate cryptographic hashes and multi-scheme hash-based digital signature verification circuitry 320 coupled with the shared cryptographic hash circuitry. The multi-scheme hash-based digital signature verification circuitry is multi-scheme because it is operable to use the shared cryptographic hash circuitry 323 to verify digital signatures according to either one of a first hash-based digital signature verification scheme and a second, different hash-based digital signature verification scheme. As shown, the multi-scheme hash-based digital signature verification circuitry may optionally include a first hash-based digital signature verification scheme circuitry 321 to implement the first hash-based digital signature scheme (e.g., use the cryptographic hash circuitry to verify digital signatures according to the first hash-based digital signature scheme) and a second hash-based digital signature verification scheme circuitry 322 to implement the second hash-based digital signature scheme (e.g., use the cryptographic hash circuitry to verify the digital signatures according to the second hash-based digital signature scheme). In some embodiments, the shared cryptographic hash circuitry may be shared by the first circuitry 321 and the second circuitry 322. In some cases, the multi-scheme hash-based digital signature verification circuitry may optionally be operable to use the cryptographic hash circuitry 323 to verify digital signatures according to a third still different hash-based digital signature scheme.

Examples of suitable hash-based digital signature verification schemes include, but are not limited to, LMS based digital signature verification schemes, XMSS based digital signature verification schemes, other known hash-based digital signature verification schemes, and other hash-based digital signature verification schemes developed in the future. As used herein, the terms “LMS based digital signature verification schemes” refers collectively to LMS digital signature verification schemes, the multi-tree variant of LMS known as Hierarchical Signature System (HSS) digital signature verification schemes, future releases or versions of LMS and HSS digital signature verification schemes, derivatives of LMS and HSS digital signature verification schemes, and other schemes based on or derived from LMS and HSS digital signature verification schemes, whether or not they retain the name LMS and HSS. As used herein, the terms “XMSS based digital signature verification schemes” refers collectively to XMSS digital signature verification schemes, multi-tree XMSS (XMSSMT) digital signature verification schemes, future releases or versions of XMSS and XMSSMT digital signature verification schemes, derivatives of XMSS and XMSSMT digital signature verification schemes, and other digital signature verification schemes based on or derived from XMSS and XMSSMT digital signature verification schemes, whether or not they retain the name XMSS and XMSSMT. LMS, HSS, XMSS, and XMSSMT are stateful digital signature schemes specified by NIST to generate digital signatures. The LMS and HSS schemes are described in Internet Research Task Force (IRTF) Request for Comments (RFC) 8554, Leighton-Micali Hash-Based Signatures, by McGrew D, Curcio M, Fluhrer S, 2019. The XMSS and XMSSMT schemes are described in Internet Research Task Force (IRTF) Request for Comments (RFC) 8391, XMSS: extended Merkle Signature Scheme, by Huelsing A, Butin D, Gazdag S, Rijneveld J, Mohaisen A, 2018.

At a high level, LMS and XMSS have some similarities. They each include two components, namely a one-time signature (OTS) scheme, and a method for creating a single, long-term public key from a large set of OTS public keys. An OTS scheme allows using a key pair to sign exactly one message securely. A Many-Time Signature (MTS) system can be used to sign multiple or many messages. OTS schemes may be used to build MTS schemes. OTS schemes and MTS schemes are called hash-based signature schemes as they utilize a cryptographic hash algorithm. Both LMS and XMSS make use of variants of the Winternitz signature scheme. XMSS is a multi-time scheme based on Merkle tree and Winternitz OTS (WOTS+). In the Winternitz signature scheme, the message to be signed is hashed to create a digest, the digest is encoded as a base b number, and then each digit of the digest is signed using a hash chain. The LMS differs from XMSS regarding the hash definitions inside the OTS and Merkle tree. The LMS and XMSS based schemes may support one or more modes, such as, for example, one or more of 192-bit and 256-bit modes. XMSS based schemes tend to provide more randomization to its internal hash functions than LMS based schemes, whereas LMS based schemes tend to provide lower computation latency than XMSS based schemes. In some embodiments, it may be useful to provide support for both and/or other schemes with distinct characteristics. Alternatively, other hash-based digital signature verification schemes with similar features or developed in the future as replacements for LMS, HSS, XMSS, or XMSSMT may optionally be used.

In some embodiments, when an LMS based digital signature verification scheme is used, the first circuitry 321 may include circuitry (e.g., a hierarchical state machine) to compute LMS based hash_chain, ots_verify, ots_compression, and Merkle-tree. The LMS based digital signature verification scheme may support one or more Merkle tree heights, such as, for example, one or more of 15 and 20. In some embodiments, when an XMSS based digital signature verification scheme is used, the second circuitry 322 may include circuitry (e.g., a hierarchical state machine) to compute XMSS based hash_chain, ots_verify, ots_compression, and Merkle-tree. XMSS based scheme verification of signatures may include computing a randomized hash of the message to be verified, generating WOTS+ public keys from signatures, compressing the computed WOTS+ public key to the Merkle tree leaf mode (L-Tree), and generating/computing the Merkle tree root node using the computed leaf and the authentication path. The XMSS based digital signature verification scheme may support one or more Merkle tree heights, such as, for example, one or more of 10, 16, and 20.

Such hash-based digital signature verification schemes are each typically based on the computation of many (e.g., thousands) of hash operations on short messages. The shared cryptographic hash circuitry 323 may be shared by (e.g., generate cryptographic hashes for) each of the first and second hash-based digital signature verification schemes (e.g., may be shared by the first circuitry 321 and the second circuitry 322). For example, an LMS based hash_chain and an XMSS based hash_chain may make repeated use of the shared cryptographic hash circuitry to generate or compute cryptographic hashes. In an embodiment where the unit optionally supports a third hash-based digital signature verification schemes, it may also share or use the shared cryptographic hash circuitry. Rather than two or more sets of cryptographic hash circuitry being dedicated for use by two or more different hash-based digital signature verification schemes, only the single shared cryptographic hash circuitry may be included, and this single shared cryptographic hash circuitry may be used and/or shared by each of the two or more different hash-based digital signature verification schemes (e.g., the first circuitry 321 and the second circuitry 322).

In some embodiments, the digital signature verification unit 308 and/or the multi-scheme hash-based digital signature verification circuitry 320 is to (e.g., alternatingly) use the cryptographic hash circuitry 323 to verify digital signatures according to only either one of the first and second hash-based digital signature verification schemes at a time. In some embodiments, the digital signature verification unit 308 and/or the multi-scheme hash-based digital signature verification circuitry 320 may only be able to verify digital signatures according to one of first and second hash-based digital signature schemes at a given time. In some embodiments, the digital signature verification unit 308 and/or the multi-scheme hash-based digital signature verification circuitry 320 may only be able to verify digital signatures according to the first and second hash-based digital signature schemes sequentially not in parallel. For example, the first circuitry 321 and the second circuitry 322 may only be able to use the cryptographic hash circuitry serially, sequentially, one after the other, or alternatingly as opposed to both being able to use it concurrently, simultaneously, or in parallel. For example, the first circuitry 321 and/or the first hash-based digital signature verification scheme may sequester or take ownership of the shared cryptographic hash circuitry for its sole use for a period of time so that the shared cryptographic hash circuitry is unavailable for use during that period of time by the second circuitry 322 and/or the second hash-based digital signature verification scheme. It is to be appreciated that the schemes need not toggle or switch back and forth after only a single verification (e.g., as in 121212121212 . . . ) but that runs of two or more or even many instances of the same scheme may occur before switching schemes (e.g., 1222222222212222111122, 1111111111121111111, 1122211222, and so on). The terms alternatingly, serially, and the like, encompass such patterns. In some embodiments, the shared cryptographic hash circuitry may have only one set of circuitry sufficient to perform hash computations (e.g., one or more rounds of cryptographic hash) for the two or more different hash-based digital signature verification scheme at a given time, as opposed to having two or more sets of circuitry each sufficient to perform hash computations (e.g., one or more rounds of cryptographic hash) for the two or more different hash-based digital signature verification scheme concurrently. In some embodiments, both the first circuitry 321 and second circuitry 322 may optionally have ports or interfaces connected to a single common shared port or interface of the shared cryptographic hash circuitry.

Advantageously, such use of the shared cryptographic hash circuitry may tend to offer one or more potential advantages, such as, for example, less circuitry and/or smaller integrated circuit or die size and/or less power consumption and/or less manufacturing cost. Another approach would be to have two separate and independent sets of cryptographic hash circuitry each dedicated for use by a different respective one of the first and second circuitries and/or their associated first and second verification schemes. However, such replication or duplication of the cryptographic hash circuitry may tend to involve more circuitry and/or larger integrated circuit or die size and/or more power consumption and/or greater manufacturing cost. At least for certain applications, it may be sufficient for the first and second circuitries to serially, sequentially, or alternatingly use the shared cryptographic hash circuitry.

Examples of suitable cryptographic hash algorithms or hashes for the shared cryptographic hash circuitry include, but are not limited to, SHA-2 based algorithms or hashes, SHA-3 based algorithms or hashes, SHAKE based algorithms or hashes, and BLAKE based algorithms or hashes. As used herein, the terms “SHA-2 based algorithms or hashes,” “SHA-3 based algorithms or hashes,” “SHAKE based algorithms or hashes,” and “BLAKE based algorithms or hashes,” respectively refer to SHA-2 algorithms or hashes, SHA-3 algorithms or hashes, SHAKE algorithms or hashes, and BLAKE algorithms or hashes, as well as future releases or versions of these algorithms or hashes, derivatives of these algorithms or hashes, and other schemes based on or derived from these algorithms or hashes, whether or not they respectively retain the names of SHA-2, SHA-3, SHAKE, and BLAKE. Specific examples of suitable cryptographic algorithms or hashes include, but are not limited to, SHA-256, SHA-256/192, SHAKE256/256, and SHAKE256/192. SHA-2 may comply and/or be compatible with Federal Information Processing Standards (FIPS) Publication 180-4, titled: “Secure Hash Standard (SHS)”, published by National Institute of Standards and Technology (NIST) in March 2012, and/or later and/or related versions of this standard. SHA-3 may comply and/or be compatible with FIPS Publication 202, titled: “SHA-3 Standard: Permutation-Based Hash and Extendable-Output Functions”, published by NIST in August 2015, and/or later and/or related versions of this standard. Alternatively, other cryptographic algorithms or hashes with similar features as SHA-2, SHA-3, SHAKE, or BLAKE, or developed in the future as replacements for SHA-2, SHA-3, SHAKE, or BLAKE, may optionally be used.

The multi-scheme hash-based digital signature verification circuitry 320 (e.g., first circuitry 321 and the second circuitry 322) and the shared cryptographic hash circuitry 323 may each be implemented at least partially, predominately, or fully in hardware (e.g., integrated circuitry, transistors or other circuit elements, etc.) optionally with some firmware (e.g., ROM, EPROM, flash memory, or other persistent or non-volatile memory and microcode, microinstructions, or other lower-level instructions stored therein) and/or software (e.g., higher-level instructions stored in memory). Hash-based digital signature verification may also be performed predominantly in software, but such an approach tends to be significantly slower, which may be undesirable for certain applications.

FIG. 4 is a block diagram of an embodiment of a digital signature verification unit 408 including a shared memory 425. In some embodiments, the digital signature verification unit may be used for the digital signature verification unit 108 of FIG. 1 and/or for the digital signature verification unit 208 of FIG. 2.

The digital signature verification unit includes shared cryptographic hash circuitry 423 to generate cryptographic hashes and multi-scheme hash-based digital signature verification circuitry 420 coupled with the shared cryptographic hash circuitry. The multi-scheme hash-based digital signature verification circuitry is multi-scheme because it is operable to alternatingly use the cryptographic hash circuitry to verify digital signatures according to only either one of the first and second hash-based digital signature verification schemes at a time. As shown, the multi-scheme hash-based digital signature verification circuitry may optionally include a first hash-based digital signature verification scheme circuitry 421 to implement the first hash-based digital signature scheme and a second hash-based digital signature verification scheme circuitry 422 to implement the second hash-based digital signature scheme. The multi-scheme hash-based digital signature verification circuitry and the shared cryptographic hash circuitry may optionally be the same as or similar to (e.g., have any one or more characteristics that are the same as or similar to) the correspondingly named circuitries of FIG. 3. To avoid obscuring the description, the different and/or additional characteristics of the embodiment of FIG. 4 will primarily be described, without repeating all the characteristics which may optionally be the same or similar to those already described for the embodiment of FIG. 3.

The digital signature verification unit also includes the shared memory 425. The shared memory is coupled with the multi-scheme hash-based digital signature verification circuitry 420. The shared memory may be shared by each of the first and second hash-based digital signature scheme signature verification schemes (e.g., may be used to store data for digital signatures being verified by the hash-based digital signature verification circuitry according to either one of a first hash-based digital signature scheme and a second hash-based digital signature scheme). For example, the shared memory may be shared by the first circuitry 421 and the second circuitry 422. The shared memory may also be shared by the shared cryptographic hash circuitry 423. Rather than having two memories each being dedicated for use by two or more different hash-based digital signature verification schemes, only the single shared memory may be included, and this single shared memory may be used and/or shared by each of the two or more different hash-based digital signature verification schemes (e.g., the first circuitry 421 and the second circuitry 422). By way of example, the shared memory may be a tightly coupled memory. Various sizes of the shared memory are suitable. By way of example, the memory may have a size of around 2-4 KB, or optionally a larger size if desired.

Advantageously, such use of the shared memory may tend to offer one or more potential advantages, such as, for example, a smaller integrated circuit or die size and/or less power consumption and/or less manufacturing cost. Another approach would be to have two separate and independent memories each dedicated for use by a different respective one of the first and second signature verification circuitries. However, such replication or duplication of the memory may tend to involve more circuitry and/or larger integrated circuit or die size and/or more power consumption and/or greater manufacturing cost.

In some embodiments, the shared memory may optionally have one or more read and/or write ports that have a greater bit width than 32-bits. For example, the shard memory may optionally have one or more read and/or write ports that have a bit width of at least 64-bits, at least 128-bits (e.g., a bit width of 64-bits, 128-bits, 256-bits, or 512-bits. Such read and/or write ports may help to increase the speed of accessing data from the memory as compared to the speed available from 32-bit read and write ports. Moreover, in some embodiments, the digital signature verification unit may optionally have internal registers to store certain variables or data (e.g., LMS short variables) which may further help to reduce memory access overhead.

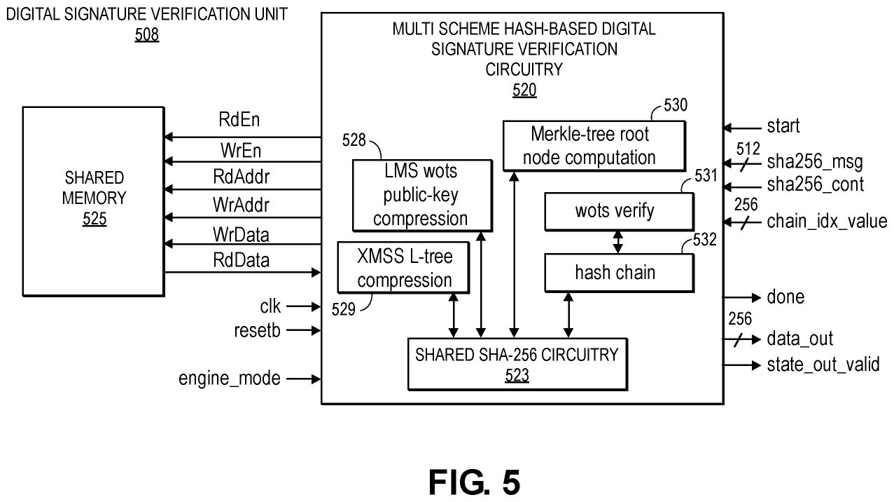

FIG. 5 is a block diagram of a detailed example embodiment of a digital signature verification unit 520. The digital signature verification unit and its components may optionally be the same as or similar to (e.g., have any one or more characteristics that are the same as or similar to) those already described. To avoid obscuring the description, the different and/or additional characteristics of the embodiment of FIG. 5 will primarily be described, without repeating all the characteristics which may optionally be the same or similar to those already described.

The digital signature verification unit includes a multi-scheme hash-based digital signature verification circuitry including shared SHA-256 circuitry 523. The multi-scheme hash-based digital signature verification circuitry is operable to use the shared cryptographic hash circuitry to verify digital signatures according to either one of an LMS based digital signature verification scheme and a XMSS based digital signature verification scheme. The LMS and XMSS based digital signature verification schemes are examples of hash-based digital signature verification schemes. The multi-scheme hash-based digital signature verification circuitry includes LMS based scheme digital signature verification circuitry to use the shared SHA-256 circuitry to verify digital signatures according to an LMS based digital signature verification scheme, and XMSS based scheme digital signature verification circuitry to use the shared SHA-256 circuitry to verify digital signatures according to an XMSS based digital signature verification scheme.

In some embodiments, the LMS based scheme digital signature verification circuitry may operate according to or at least consistent with the LMS based algorithms as described in IRTF RFC 8554 utilizing the shared SHA-256 hash circuitry. In some embodiments, the XMSS based scheme signature verification circuitry may operate according to or at least consistent with the XMSS based algorithms as described in IRTF RFC 8391 utilizing the shared SHA-256 hash circuitry. The LMS and XMSS based scheme signature verification circuitries may support one or more modes, such as, for example, one or more of 192-bit and 256-bit modes. The LMS based scheme signature verification circuitry may support one or more Merkle tree heights, such as, for example, one or more of 15 and 20. The XMSS based scheme signature verification circuitry may support one or more Merkle tree heights, such as, for example, one or more of 10, 16, and 20. In some embodiments, the shared SHA-256 hash circuitry may operate according to or at least consistent with the SHA-256 based algorithms as described in FIPS Publication 180-4. The SHA-256 circuitry is an example of shared cryptographic hash circuitry.

These circuitries include LMS wots public-key compression circuitry 528, XMSS L-tree compression circuitry 529, Merkle-tree root node computation circuitry 530, wots verify circuitry 531, and hash chain circuitry 532. In some embodiments, these components may operate as a hierarchical state machine to implement the LMS based scheme and the XMSS based scheme verifications. For the LMS based scheme digital signature verification, the wots verify circuitry 531 perform ots_verify, the wots public-key compression circuitry 528 may perform ots_compression, and the Merkle-tree root node computation circuitry 530 may perform Merkle-tree computation. These circuitries may represent LMS based scheme digital signature verification circuitry. For the XMSS based scheme digital signature verification, the hash chain circuitry 532 may compute XMSS based hash_chain, the wots verify circuitry 531 may perform wots_verify, the XMSS L-tree compression circuitry 529 may perform xmss L-tree_compression, and the Merkle-tree root node computation circuitry 530 may perform Merkle-tree computation. These circuitries may represent XMSS based scheme digital signature verification circuitry. The LMS based hash_chain and XMSS based hash_chain may make repeated use of the SHA-256 hash circuitry for their cryptographic hashes.

In some embodiments, the digital signature verification unit 508 and/or the multi-scheme hash-based digital signature verification circuitry 520 may be operable to alternatingly use the cryptographic hash circuitry 523 to verify digital signatures according to only either one of the first and second hash-based digital signature verification schemes at a time. For example, the LMS circuitry 521 and the XMSS circuitry 522 may only be able to use the cryptographic hash circuitry serially, sequentially, one after the other, or alternatingly as opposed to both being able to use it concurrently, simultaneously, or in parallel. For example, the XMSS circuitry 522 and/or the XMSS based digital signature verification scheme may sequester or take ownership of the shared SHA-256 circuitry for its sole use for a period of time so that the shared SHA-256 circuitry is unavailable for use during that period of time by the LMS circuitry 521 and/or the LMS based digital signature verification scheme. In some embodiments, the SHA-256 hash circuitry may have only one set or instance of SHA-256 hash circuitry sufficient to perform hash computations (e.g., one or more rounds of cryptographic hash) for one of the LMS and XMSS based scheme signature verification circuitries at a given time, as opposed to the SHA-256 hash circuitry having two or more sets or instances of SHA-256 hash circuitry each sufficient to perform hash computations (e.g., one or more rounds of cryptographic hash) for one of the LMS and XMSS based scheme signature verification circuitries at the same time. This may tend to help reduce the size of the integrated circuit or die and/or the power consumption of the integrated circuit or die and/or the manufacturing cost of the integrated circuit or die, as previously described.

The multi-scheme hash-based digital signature verification circuitry and the shared SHA-256 circuitry may each be implemented at least partially, predominately, or fully in hardware (e.g., integrated circuitry, transistors or other circuit elements, etc.) optionally with some firmware (e.g., ROM, EPROM, flash memory, or other persistent or non-volatile memory and microcode, microinstructions, or other lower-level instructions stored therein) and/or some software (e.g., higher-level instructions stored in memory).

Referring again to FIG. 5, the digital signature verification unit 508 also includes the shared memory 525. The shared memory may be shared by (e.g., store data for) the LMS based digital signature verification scheme (e.g., the LMS circuitry) and the XMSS based digital signature verification scheme (e.g., the XMSS circuitry). That is, rather than having two or more memories each used by only one of the LMS and XMSS based digital signature verification schemes, the single shared memory may be used by both LMS and XMSS based digital signature verification schemes. The use of the shared memory may tend to offer one or more potential advantages, such as, for example, a smaller integrated circuit or die size and/or less power consumption and/or less manufacturing cost.

In some embodiments, the shared memory may be a tightly coupled memory. Various sizes of the shared memory are suitable. By way of example, the memory may have a size of around 2-4 KB, or optionally a larger size if desired. In some embodiments, the shared memory may optionally have one or more read and/or write ports that have a greater bit width than 32-bits. For example, the shard memory may optionally have one or more read and/or write ports that have a bit width of more than 64-bits or more than 128-bits (e.g., 64-bits, 128-bits, 256-bits, 512-bits, or optionally even larger). Such read and/or write ports may help to increase the speed of accessing data from the memory as compared to the speed available from 32-bit read and write ports.

Referring again to FIG. 5, the digital signature verification unit 508 includes several input and output ports and buses and/or lines. Each of these ports and buses/lines has a name or label (e.g., RdEn, WrEn, clk, resetb). Table 1 lists these names and the associated function of the ports and buses/lines.

TABLE 1
Ports and buses/lines and their functions

| Input/Output | Function |
|---|---|
| clk | an input port to receive a clock signal |
| resetb | an input port to receive a reset signal |
| | (e.g., reset at logic zero and default to |
| | logic one for normal operation) |
| engine_mode | an input port (e.g., a 4-bit input port) |
| | to receive an engine mode selection signal |
| start | an input port to receive a start |
| | pulse to initiate the unit |
| sha256_msg | a 512-bit input port to receive a 512-bit |
| | message block input when the engine |
| | operates in engine_mode = 0 and is |
| | not used for engine_mode = 1 |
| sha256_cont | an input port to receive a signal to indicate |
| | the continuation of the SHA256 |
| | operation with a new 512-bit message |
| | block input when the engine operates in |
| | engine_mode = 0. This may represent a |
| | message valid signal for subsequent |
| | message blocks. This signal is applied |
| | after receiving a state_out_valid = 1 |
| | signal. This port is not used for |
| | engine_mode = 1 |
| chain_idx_ | a 256-bit input port to receive a |
| value | 256-bit message representative (m′) for |
| | engine_mode = 1 |
| RdData | an input bus or lines to receive data |
| | read from the shared memory. In some |
| | embodiments, this bus/lines may have |
| | more than 32-bits (e.g., 64-bits, 128- |
| | bits, or 256-bits) |
| RdEn | an output bus or line (e.g., a 1-bit line) |
| | to provide a read enable signal to the |
| | shared memory |
| WrEn | an output bus or line (e.g., a 1-bit line) |
| | to provide a write enable signal to the |
| | shared memory |
| RdAddr | an output bus or lines (e.g., of 7-bits) |
| | to provide a read address (e.g., a 7-bit |
| | read address) to the shared memory |
| WrAddr | an output bus or lines (e.g., of 7-bits) |
| | to provide a write address (e.g., a 7-bit |
| | write address) to the shared memory |
| WrData | an output bus or lines to provide write |
| | data to the shared memory. In some |
| | embodiments, this bus/lines may have |
| | more than 32-bits (e.g., 64-bits, 128- |
| | bits, or 256-bits) |
| data_out | an output bus or lines (e.g., of 256-bits) |
| | to provide 256-bit sha256 state output |
| | for engine_mode = 0, and to provide the |
| | xmss_verify output for engine_mode = |
| | 1. For engine_mode = 1, PASS may be |
| | indicated by data_out having a first |
| | predetermined value (e.g., as one example |
| | 256′haaaaaaaaaaaaaaaaaaaaaaaaaaaaaaa |
| | aaaaaaaaaaaaaaaaaaaaaaaaaaaaaaaaa), |
| | and FAIL may be indicated by |
| | data_out having a second, different |
| | predetermined value (e.g., as one example |
| | 256′h8888888888888888888888888888 |
| | 888888888888888888888888888888888888). |
| | The use of a multi-bit pass/fail indication |
| | (e.g., a 256-bit pass/fail indication) may help to |
| | provide resiliency as compared to a trivial 1-bit |
| | pass/fail indication to protect against |
| | single-point-of-failure. However, the use |
| | of 256-bit pass/fail indications are |
| | not required. Other multi-bit pass/fail |
| | indications may optionally be used (e.g., |
| | 2-bit, 8-bit, 32-bit, 64-bit, 128-bit). |
| state_out_ | an output bus or line (e.g., a 1-bit line) |
| valid | to indicate the sha256 state output as |
| | being valid or invalid |
| done | an output bus or line (e.g., a 1-bit line) |
| | to provide a pulse or signal to indicate |
| | that the current xmss_verfy is completed |
| | and the output is available at the |
| | data_out output bus or lines. The output |
| | may be captured once done indicates |
| | completed (e.g., done = 1) |

As shown in FIG. 5, and as discussed above, the digital signature verification unit 508 has the engine_mode input port (e.g., a 4-bit input port) to receive an engine mode selection signal. The engine mode selection signal may control and/or configure a mode of operation (e.g., a hardware configuration) of the multi-scheme serial digital signature verification unit so that it performs different operations. In some embodiments, the multi-scheme serial digital signature verification unit may support the engine modes shown in Table 2.

TABLE 2
Engine modes and respective functionality

| Engine_Mode | Functionality |
|---|---|
| 0 | Configure the shared SHA-256 |
| | circuitry for external use |
| 1 | Precompute intermediate SHA-256 state |
| | m′ after absorbing (OPCODE \|\| r \|\| |
| | root \|\| 256b-extension of idx_sig) for |
| | XMSS verify. This may help to simplify |
| | the external wrapper by avoiding the |
| | need for circuitry to access the LMS- |
| | XMSS local memory. |
| 2 | Perform XMSS verify with |
| | XMSS-SHA2_16_256 parameters |
| 3 | Perform XMSS verify with |
| | XMSS-SHA2_20_256 parameters |
| 4 | Perform XMSS verify with |
| | XMSS-SHA2_16_192 parameters |
| 5 | Perform XMSS verify with |
| | XMSS-SHA2_20_192 parameters |
| 6 | Perform LMS verify with LMS-SHA2_15_256 parameters |
| 7 | Perform LMS verify with LMS-SHA2_20_256 parameters |
| 8 | Perform LMS verify with LMS-SHA2_15_192 parameters |
| 9 | Perform LMS verify with LMS-SHA2_20_192 parameters |

In engine modes 2-9, the 15, 16, and 20 refer to the Merkle tree height and the 192 and 256 refer to the parameters of the schemes. For 192-bit parameters, the same datapath and memory blocks may be used with the least significant 192-bits. Support for multiple heights and multiple parameters helps to add flexibility but is not required.

It is to be appreciated that this is just one illustrative example of a suitable set of engine modes. Other embodiments may support fewer or more engine modes and different engine modes. For example, engine modes may optionally be provided for fewer or more and different Merkle heights (e.g., only 20, not 16 and 20 but only 10) and/or fewer or more and different parameters (e.g., only 256, only 192). Also, the mapping of the 4-bit code to the engine mode is arbitrary and is only one of many mappings that may optionally be used instead.

It is to be appreciated that this is just one illustrative example of a suitable multi-scheme serial digital signature verification unit. Many variations and alternatives to this multi-scheme serial digital signature verification unit are contemplated and will be apparent to those skilled in the art and having the benefit of the present disclosure. For example, in other embodiments, one or more of the LMS and XMSS based scheme signature verification circuitry may optionally be replaced by another hash-based digital signature scheme signature verification circuitry, as previously described. As another example, in other embodiments, the shared SHA-256 hash circuitry may optionally be replaced by another type of shared cryptographic hash circuitry (e.g., shared SHA-3, SHAKE, or BLAKE cryptographic hash circuitry). Yet another example, in other embodiments, the shared memory may optionally be replaced with two memories each dedicated to one of the different signature verification circuitries.

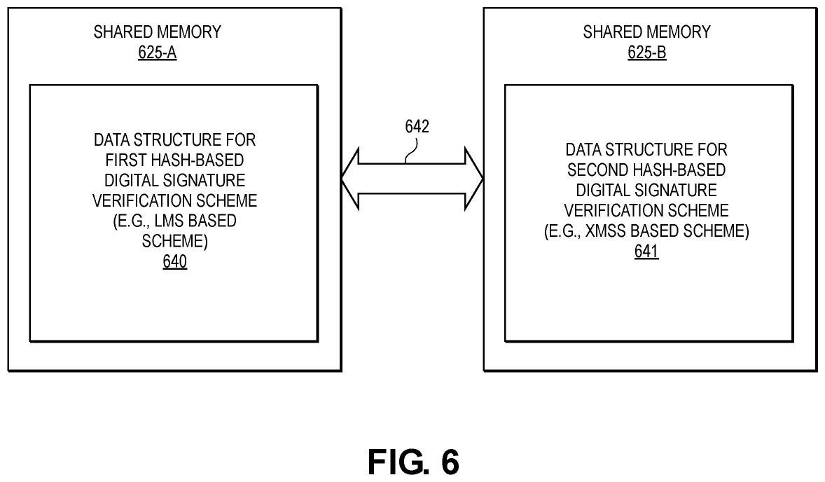

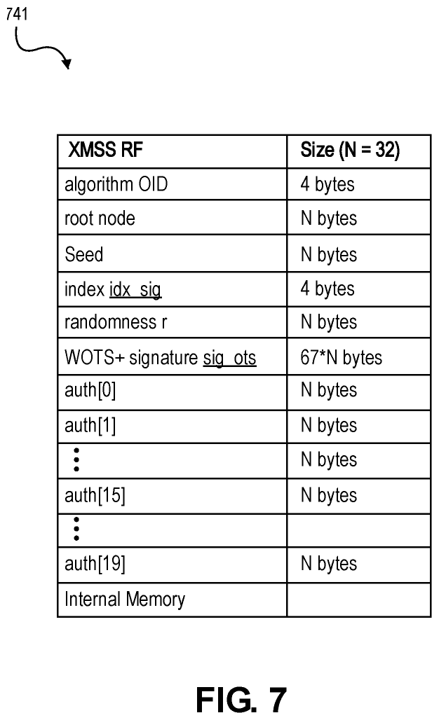

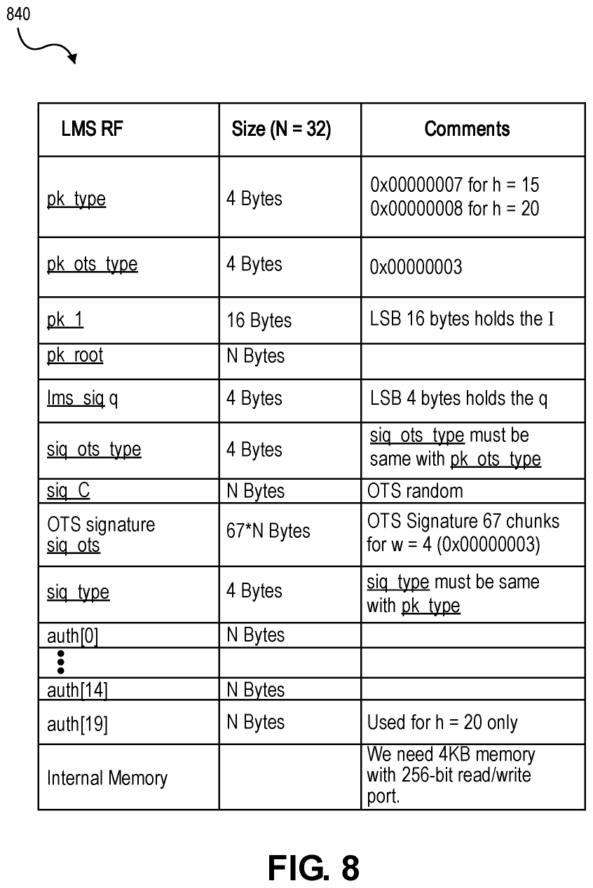

FIG. 6 is a block diagram illustrating that in some embodiments a shared memory 625-A, 625-B (e.g., shared memory 423 and/or shared memory 523) may alternatingly 642 be used to store either a data structure 640 for a first hash-based digital signature verification scheme (e.g., a data structure for an LMS based digital signature verification scheme) or a data structure 641 for a second hash-based digital signature verification scheme (e.g., a data structure for an XMSS based digital signature verification scheme). The data structures may have defined content (e.g., the parameters and variables involved in the scheme) and defined fields and/or defined memory layouts for the content. FIG. 7 illustrates a specific example embodiment of a suitable data structure 741 (e.g., a memory organization) for an XMSS based digital signature verification scheme. FIG. 8 illustrates a specific example embodiment of a suitable data structure 840 (e.g., a memory organization) for an LMS based digital signature verification scheme.

To further illustrate certain concepts, consider the following detailed examples of how a digital signature verification unit may verify digital signatures for XMSS and LMS. First XMSS will be discussed, and then later below LMS will be discussed.

Initially, the XMSS M′ computation may be performed. The randomized hash value of the message (32 bytes) to be verified is the input to the engine. The current engine supports two ways to compute it: (1) computed completely by the wrapper (Engine mode=0); and (2) computed by the digital signature verification unit and by the wrapper (Engine mode=1). First, we will describe computing it completely by the wrapper. At this engine mode the interface of the internal SHA256 engine is open to the wrapper/driver to perform any SHA256 hash function. The computation of the message representative (m′) for XMSS with engine_mode=0 is represented by the following equation:

Message representative (or chain_idx_value)=SHA256 (OPCODE∥r∥root∥256b-extension of idx_sig∥message_to_be_signed)

In this equation, OPCODE is It is a 256-bit representation of integer 2 (e.g., 0000000000000000000000000000000000000000000000000000000000000002). The parameter “r” represents the 256-bit random value used in the signature, which is a part of the XMSS signature. The “root” is a 256-bit value represents the Merkle tree root node or root node in part of the public key. The value “idx_sig” is a 32-bit number which is a part of the XMSS signature. In the above equation, idx_sig is represented as 256-bit value as: 224-bit 0's∥32-bit idx_sig. The message_to_be_signed could be the entire image or a 384-bit digest of the image. In the case of the 384b digest, then the SHA256 message blocks are: (1) OPCODE∥r; (2) root∥256b-extension of idx_sig; and (3) 384b of digest∥1′b1∥63′d0∥64′d1408.

For computing this operation, the driver (e.g., FW or HW wrapper) can utilize the internal SHA256 cryptographic circuitry. At the initial condition, the unit may keep its SHA256 engine open for external user to perform message hashing. The message representative (m′) may be computed by: (1) setting the engine mode to 0; (2) applying 512b sha256_msg=OPCODE∥r; (3) applying a start=1 pulse; (4) waiting for state_out_valid=1; (5) applying a 512b sha256_msg=root∥224-bit 0′s∥32-bit idx_sig; (6) applying a sha256_cont=1 pulse; (7) waiting for state_out_valid=1; (8) applying a 512b sha256_msg=512b of message part; (9) applying a sha256_cont=1 pulse; (10) waiting for state_out_valid=1; (11) determining whether the end of all message blocks including padding and length information has been reached; (12) if the end has not been reached then cycling back through (8)-(11); and (13) if the end has been reached then capturing the computed m′=data_out at the time of state_out_valid=1.

Now the second way of computing m′ by the digital signature verification unit and by the wrapper (engine mode=1) will be described. After loading all information to the shared memory, the wrapper may set the engine_mode=1. The digital signature verification unit may computes the hash of (OPCODE∥r∥root∥256b-extension of idx_sig) and generate the SHA256 state with state_out_valid=1. Once the engine produces the intermediate SHA256 results with state_out_valid=1, the output state may be used for computing the m′. To compute the m′ using the digital signature verification unit, the wrapper may perform the following operations: (1) the wrapper will set the engine_mode=0; (2) apply sha256_cont=1 and corresponding sha256_msg and compute the rest of the SHA256 operations to compute the m′. For example, if a message is expressed as a 256-bit hexadecimal value “256′h54686973206d657373616765206e6565647320746f206265207369676e656400” then apply sha256_msg={256′h54686973206d657373616765206e6565647320746f206265207369676e656400,1′b1,191′d0,64′d1280}; and sha256_cont=1. In such a case, you would expect the computed m′=256′hbac3c48674ec0d5e5888d4f21f4975587fd9d1d206e48c3253301a0e9a1e4c88. Note that it is expected that the wrapper does not apply any reset or start in between engine_mode=1 and engine_mode=0. That will remove the digital signature verification unit's state to continue the m′ computation. The wrapper will continue with sha256_cont signal to complete rest of the SH256 operations for computing m′

Now XMSS verify operations will be described. This may be performed at engine_mode=2 for h=16 and engine_mode=3 for h=20. Once the wrapper completes the randomized-message hashing, it provides the digest to the 256-bit chain_idx_value port, writes all other inputs to the shared memory (e.g., with the location information as shown in FIG. 7, sets the engine_mode=2 (XMSS-Verify), and then generates a start pulse. After receiving the engine_mode=2 and the start pulse, the digital signature verification unit may lock its external interfaces and executes the XMSS verify steps atomically. At the end of execution, the digital signature verification unit may generate a done pulse (logic high for a single clock) and the corresponding final computed output may be captured from the data_out port. The wrapper should capture the output when done=1.

Now LMS message representative computation will be described. This operation may be done using the engine mode=0. It is computed as shown in the following equation:

$$Q = H ( I ‖ u 32 str ( q ) ‖ u 16 str ( D\_MESG ) ‖ C ‖ message )$$

In the above equation, the parameter I is a 16-byte string that indicates which Merkle tree this LM-OTS is used with. The value of I would be available as a part of the public key. The parameter q is a 32-bit (or 4-byte) integer that indicates the leaf of the Merkle tree where the OTS public key appears. It would be available inside the LMS signature. D_MESG=0x8181 is a fixed 2-byte string. C is a 32-byte random used in the LMS signature. The computed 256-bit message representation Q would be applied to the engine through the chain_idx_value input port.

LMS verify operations will now be described. These may be performed at engine_mode=6 for h=15 and engine_mode=7 for h=20. The digital signature verification unit may expect that the message representative Q is applied to the chain_idx_value input port when engine_mode is set to 6 or 7 and a start pulse is applied. With this input condition, the digital signature verification unit may start execution of the LMS verify operations. It may start with the checksum computation and may end with the pass/fail indication by comparing the computed Merkle tree root node and the expected root in the public key. The digital signature verification unit may also expect that the entire public key and the LMS signature are loaded into its local memory/register-file in appropriate location (e.g., as shown in FIG. 8.

For the checksum computation, the engine may supports w=4, which means that the message representative Q is broken into 64 parts each of which are a 4-bit nibble which are represented as a [i], 0≤i≤63. The checksum computation may compute a 12-bit checksum for 64 nibbles as follows

sum = 0
for ( i = 0; i < 64; i = i + 1 ) {
sum = sum + (2\hat{ }w − 1) − a[i]

The 12-bit sum may then be stored to the array elements a [66], a [65], and a [64], where the least significant 4-bits may be stored into a [64] and so on.

Then an OTS public key may be computed from the signature. The digital signature verification unit may compute 67 OTS public key chunks z [i], 0≤i≤66 from 67 signature components y [i], 0≤i≤66 that are stored in the register file locations 7 to 73. Each OTS public key component z [i], 0≤i≤66 may be computed by following iterative operations:

tmp = y[i]
for ( j = a[i]; j < 2\hat{ }w − 1; j = j + 1 ) {
tmp = H(I || u32str(q) || u16str(i) || u8str(j) || tmp)
}
z[i] = tmp

Although all 67 chunks of the public key are independent and can be computed in parallel, we compute all hash operations serially on the same SHA256 cryptographic circuit. This reduces the die-area of the LMS-XMSS digital signature verification unit while providing an acceptable performance for LMS and XMSS signature verifications.

The digital signature verification unit may read 16-byte I and 4-byte q only once from the shared memory and stores them in a temporary internal register for the following uses for all H functions in OTS as well as for other hash operations in LMS verify (including the computations of Kc and Merkle tree root node). The unit may form the 64-byte SHA256 message block for H function by concatenating 16-byte I, 4-byte q, 2-byte i, 1-byte j, 32-byte tmp followed by the OCS_LMS_PAD_55B=0x8000000000000001B8. The unit may then assert a start signal to the SHA256 engine and apply this SHA256 message block input and wait for the hash_valid=1. Once it receives the hash_valid=1, it may increment the j counter by 1 and if j is still less than 15 then it may iterate to the next tmp computation. Otherwise, it may store the computed tmp (=z [i]) to the same location of y [i]. In other words, the digital signature verification unit may overwrite the value of the z [i] on y [i] to reduce additional memory requirement. This is optional not required.

OTS public key compression may then be performed. This may involve the compression of the 67 OTS public key chunks to a single n-byte value (Kc) which may be computed as shown in the following equation:

$$Kc = H ( I ‖ u 32 str ( q ) ‖ u 16 str ( D\_PBLC ) ‖ z [ 0 ] ‖ z [ 1 ] ‖ … ‖ z [ 66 ] ) ,$$

In this equation D_PBLC=0x8080 and the values of I and q are available into the shared memory (e.g., at locations 2 and 4 in FIG. 8).

The digital signature verification unit may then compute Kc. The value of I and q may in some cases be taken from the temporary internal registers inside the unit, which may be loaded from the shared memory in the beginning of OTS operation. The unit may read two consecutive z [i] and z [i+1] from memory and store them into the tmp_reg and tmp_reg2 temporary registers respectively. For the first SHA256 execution it sets the 64B message block as follows:
(16B-I∥4B-q∥2B-dpub∥32B-tmp_reg∥10B-MSB-RdData),

In the expression above, RdData is stored into the tmp_reg2 in parallel with the start of the SHA256 operation. For the following SHA256 executions the message blocks are formed as:
(22B-LSB-tmp_reg2∥32B-tmp_reg∥10B-MSB-RdData).

The final message block is formed as:
(22B-LSB-tmp_reg2∥tmp_reg∥′OCS_LMS_PAD_2166B),

In the above expression, OCS_LMS_PAD_2166B=80′h800000000000000043B0 (i.e., 2B-PAD+8B-Length). The final digest or Kc value is written into the first location of the LMS OTS Signature (e.g., location 0x7 in the shared memory). Additionally, the value of Kc will remain available at the sha256_state_out signal. It may be used directly for the first hash computation in the OCS_LMS_MERKLE state.

Next operations may be performed to compute the root node (Tc) of the Merkle tree from Kc and authentication path nodes. In some cases, this may involve a variation with the tree height between h=15 and h=20 in the unit. For h=20 the root node computation may include 5 additional H operations to go through 5 more tree levels. It may be computed as follows according to the following pseudocode

```
node_num = 2\hat{ }h + q
  tmp = H(I || u32str(node_num) || u16str(D_LEAF) || Kc)
  i = 0
  while (node_num > 1) {
    if (node_num is odd):
      tmp = H(I || u32str(node_num/2) || u16str(D_INTR) ||
      path[i] || tmp)
    else:
      tmp = H(I || u32str(node_num/2) || u16str(D_INTR) ||
      tmp || path[i])
    node_num = node_num/2
    i = i + 1
  }
  Tc = tmp
```

The values of D_LEAF=0x8282 and D_INTR=0x8383. The digital signature verification unit may compute the Merkle tree root node from the Kc and authentication path nodes iteratively from leaf to root. Reinitialize the register q_reg by 2\hat{ }h+q. The first H function is computed as a SHA256 execution on the 64B message block as follows:
(16B-I∥4B-q∥2B-dleaf∥32B-sha256_state_out∥′OCS_LMS_PAD_54B)

In this expression, OCS_LMS_PAD_54B=80′h800000000000000001B0 (e.g., 2B-PAD+8B-Length). Each of the intermediate H function may be computed with two SHA256 executions where first one is computed with the 64B message block as follows:

If q_reg[0] == 1 then (16B-I || 4B-q || 2B-dintr || 32B-RdData,
10B-MSB-sha256_state_out)
Else (16B-I || 4B-q || 2B-dintr || 32B-sha256_state_out,
10B-MSB-RdData)

In these expressions RdData may hold the authentication path [i] and i may represent the Merkle tree levels which is implemented by the counter lms_merkle_cnt.

After computing the first SHA256 with hash_start=1, the next SHA256 continues with the following remaining 64B message block of the respective H call as follows:

If q_reg[0] == 1 then (22B-LSB-sha256_state_out ||
OCS_LMS_PAD_86B)
Else (22B-LSB-RdData || OCS_LMS_PAD_86B) where,

OCS_LMS_PAD_86B is a 226 bit hexadecimal value represented by 336′h8000000000000000000000000000000000000000000000000000000000000000000000000 000000002B0. A left shift of the q_reg is used to compute the node_num/2 and check if the updated q_reg>1. Based on the result of this conditional check the process may iterate through or move into the next steps toward finalization of the comparison of the computed Merkle tree root node with the expected public key root node which was stored in the appropriate location in the shared memory (e.g., location 0x3 in FIG. 8).

It is to be appreciated that the approach described above for FIG. 5 is just one illustrative example approach that may be used. In other embodiments, the digital signature verification may be performed in different ways. For example, the digital signature verification may be specified in terms of either finer or coarser granularity of calculations. For example, in the case of coarser granularity, a single instruction or command may specify that the entire digital signature verification be performed as opposed to separate instructions, commands, or controls being used to change engine mode as described for FIG. 5 (e.g., switching from engine mode 0 to engine mode 2). As one example, a macroinstruction or instruction of an instruction set of a processor may specify (e.g., have an opcode that specifies) that an entire digital signature verification be performed. By way of example, the instruction may specify or otherwise indicate (e.g., have one or more fields in its encoding to specify or otherwise indicate) one or more memory locations, registers, or other storage locations having the inputs to the digital signature verification (e.g., messages or data, a signature, parameters, etc.). The various inputs disclosed herein are suitable. These inputs may be in data structures, command buffers, architecturally defined layouts, or the like. A processor may perform operations corresponding to the instruction including to perform digital signature verification and provide a pass/fail indication. In this way the entire digital signature verification may be performed responsive to a single instruction. Similarly, an application binary interface (ABI) command or similar type of command may be used to specify a digital signature verification. Such a command may also be performed at various granularities. Such an ABI command may control a processor (e.g., a CPU or a security processor) to perform digital signature verification. In one aspect, commands for finer granularity computations (e.g., akin to the engine mode switches disclosed for FIG. 5) may optionally be used. In another aspect, commands for coarser granularity computations (e.g., akin to those described for the macroinstruction earlier in this paragraph may optionally be used.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

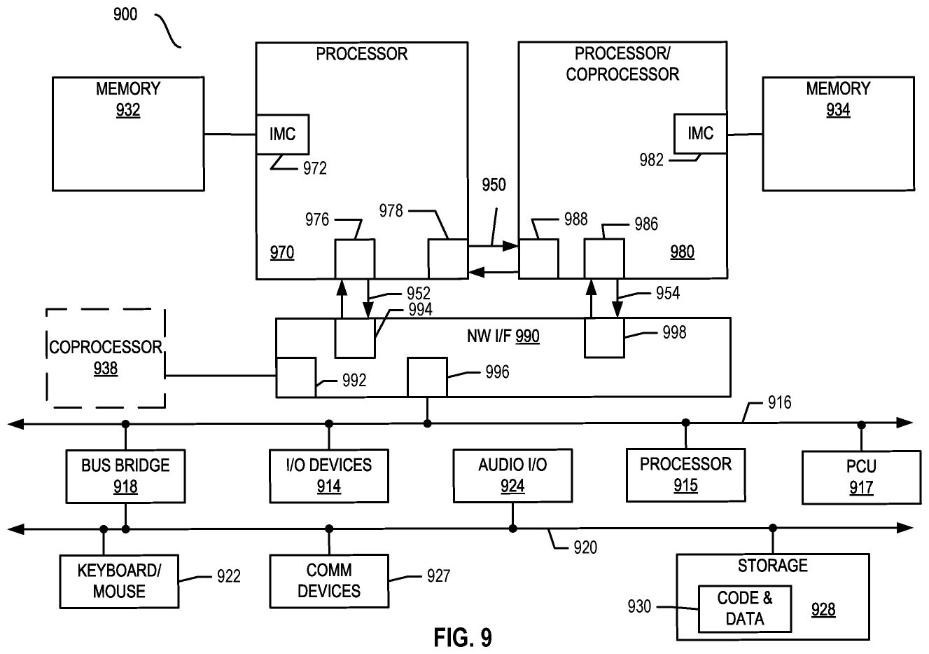

FIG. 9 illustrates an example computing system. Multiprocessor system 900 is an interfaced system and includes a plurality of processors or cores including a first processor 970 and a second processor 980 coupled via an interface 950 such as a point-to-point (P-P) interconnect, a fabric, and/or bus. In some examples, the first processor 970 and the second processor 980 are homogeneous. In some examples, first processor 970 and the second processor 980 are heterogenous. Though the example system 900 is shown to have two processors, the system may have three or more processors, or may be a single processor system. In some examples, the computing system is a system on a chip (SoC).

Processors 970 and 980 are shown including integrated memory controller (IMC) circuitry 972 and 982, respectively. Processor 970 also includes interface circuits 976 and 978; similarly, second processor 980 includes interface circuits 986 and 988. Processors 970, 980 may exchange information via the interface 950 using interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a network interface (NW I/F) 990 via individual interfaces 952, 954 using interface circuits 976, 994, 986, 998. The network interface 990 (e.g., one or more of an interconnect, bus, and/or fabric, and in some examples is a chipset) may optionally exchange information with a coprocessor 938 via an interface circuit 992. In some examples, the coprocessor 938 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 970, 980 or outside of both processors, yet connected with the processors via an interface such as P-P interconnect, such that either or both processors' local cache information may be stored in the shared cache if a processor is placed into a low power mode.

Network interface 990 may be coupled to a first interface 916 via interface circuit 996. In some examples, first interface 916 may be an interface such as a Peripheral Component Interconnect (PCI) interconnect, a PCI Express interconnect or another I/O interconnect. In some examples, first interface 916 is coupled to a power control unit (PCU) 917, which may include circuitry, software, and/or firmware to perform power management operations with regard to the processors 970, 980 and/or co-processor 938. PCU 917 provides control information to a voltage regulator (not shown) to cause the voltage regulator to generate the appropriate regulated voltage. PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software.

Various I/O devices 914 may be coupled to first interface 916, along with a bus bridge 918 which couples first interface 916 to a second interface 920. In some examples, one or more additional processor(s) 915, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 916. In some examples, second interface 920 may be a low pin count (LPC) interface. Various devices may be coupled to second interface 920 including, for example, a keyboard and/or mouse 922, communication devices 927 and storage circuitry 928. Storage circuitry 928 may be one or more non-transitory machine-readable storage media as described below, such as a disk drive or other mass storage device which may include instructions/code and data 930 and may implement the storage ‘ISAB03 in some examples. Further, an audio I/O 924 may be coupled to second interface 920. Note that other architectures than the point-to-point architecture described above are possible. For example, instead of the point-to-point architecture, a system such as multiprocessor system 900 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

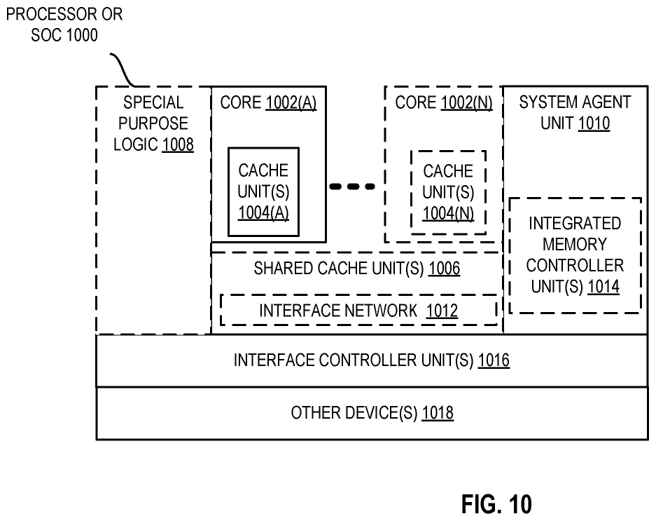

FIG. 10 illustrates a block diagram of an example processor and/or SoC 1000 that may have one or more cores and an integrated memory controller. The solid lined boxes illustrate a processor 1000 with a single core 1002(A), system agent unit circuitry 1010, and a set of one or more interface controller unit(s) circuitry 1016, while the optional addition of the dashed lined boxes illustrates an alternative processor 1000 with multiple cores 1002(A)-(N), a set of one or more integrated memory controller unit(s) circuitry 1014 in the system agent unit circuitry 1010, and special purpose logic 1008, as well as a set of one or more interface controller units circuitry 1016. Note that the processor 1000 may be one of the processors 970 or 980, or co-processor 938 or 915 of FIG. 9.

Thus, different implementations of the processor 1000 may include: 1) a CPU with the special purpose logic 1008 being integrated graphics and/or scientific (throughput) logic (which may include one or more cores, not shown), and the cores 1002(A)-(N) being one or more general purpose cores (e.g., general purpose in-order cores, general purpose out-of-order cores, or a combination of the two); 2) a coprocessor with the cores 1002(A)-(N) being a large number of special purpose cores intended primarily for graphics and/or scientific (throughput); and 3) a coprocessor with the cores 1002(A)-(N) being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1004(A)-(N) within the cores 1002(A)-(N), a set of one or more shared cache unit(s) circuitry 1006, and external memory (not shown) coupled to the set of integrated memory controller unit(s) circuitry 1014. The set of one or more shared cache unit(s) circuitry 1006 may include one or more mid-level caches, such as level 2 (L2), level 3 (L3), level 4 (L4), or other levels of cache, such as a last level cache (LLC), and/or combinations thereof. While in some examples interface network circuitry 1012 (e.g., a ring interconnect) interfaces the special purpose logic 1008 (e.g., integrated graphics logic), the set of shared cache unit(s) circuitry 1006, and the system agent unit circuitry 1010, alternative examples use any number of well-known techniques for interfacing such units. In some examples, coherency is maintained between one or more of the shared cache unit(s) circuitry 1006 and cores 1002(A)-(N). In some examples, interface controller units circuitry 1016 couple the cores 1002 to one or more other devices 1018 such as one or more I/O devices, storage, one or more communication devices (e.g., wireless networking, wired networking, etc.), etc.

In some examples, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous in terms of instruction set architecture (ISA). Alternatively, the cores 1002(A)-(N) may be heterogeneous in terms of ISA; that is, a subset of the cores 1002(A)-(N) may be capable of executing an ISA, while other cores may be capable of executing only a subset of that ISA or another ISA.

### Example Core Architectures—In-Order and Out-of-Order Core Block Diagram.

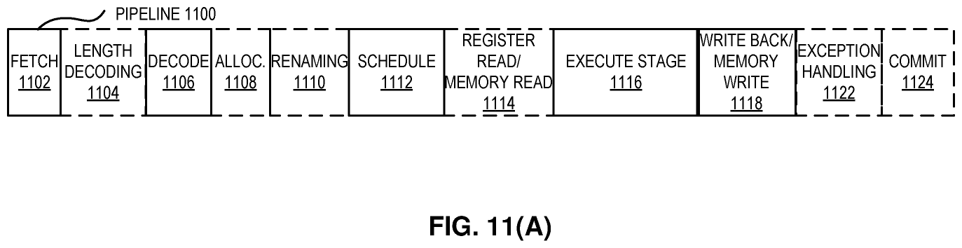

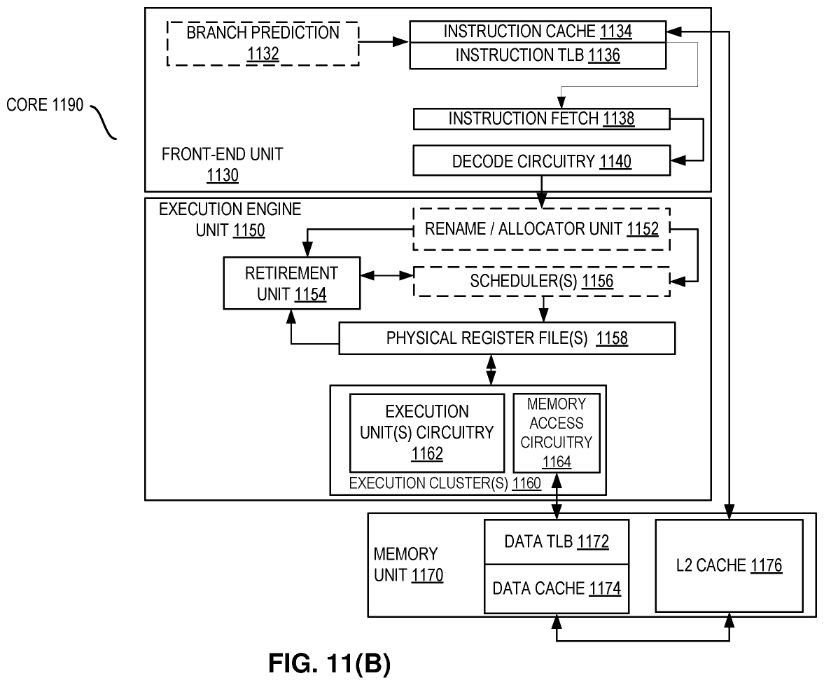

FIG. 11(A) is a block diagram illustrating both an example in-order pipeline and an example register renaming, out-of-order issue/execution pipeline according to examples. FIG. 11(B) is a block diagram illustrating both an example in-order architecture core and an example register renaming, out-of-order issue/execution architecture core to be included in a processor according to examples. The solid lined boxes in FIGS. 11(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11(A), a processor pipeline 1100 includes a fetch stage 1102, an optional length decoding stage 1104, a decode stage 1106, an optional allocation (Alloc) stage 1108, an optional renaming stage 1110, a schedule (also known as a dispatch or issue) stage 1112, an optional register read/memory read stage 1114, an execute stage 1116, a write back/memory write stage 1118, an optional exception handling stage 1122, and an optional commit stage 1124. One or more operations can be performed in each of these processor pipeline stages. For example, during the fetch stage 1102, one or more instructions are fetched from instruction memory, and during the decode stage 1106, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1106 and the register read/memory read stage 1114 may be combined into one pipeline stage. In one example, during the execute stage 1116, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 11(B) may implement the pipeline 1100 as follows: 1) the instruction fetch circuitry 1138 performs the fetch and length decoding stages 1102 and 1104; 2) the decode circuitry 1140 performs the decode stage 1106; 3) the rename/allocator unit circuitry 1152 performs the allocation stage 1108 and renaming stage 1110; 4) the scheduler(s) circuitry 1156 performs the schedule stage 1112; 5) the physical register file(s) circuitry 1158 and the memory unit circuitry 1170 perform the register read/memory read stage 1114; the execution cluster(s) 1160 perform the execute stage 1116; 6) the memory unit circuitry 1170 and the physical register file(s) circuitry 1158 perform the write back/memory write stage 1118; 7) various circuitry may be involved in the exception handling stage 1122; and 8) the retirement unit circuitry 1154 and the physical register file(s) circuitry 1158 perform the commit stage 1124.

FIG. 11(B) shows a processor core 1190 including front-end unit circuitry 1130 coupled to execution engine unit circuitry 1150, and both are coupled to memory unit circuitry 1170. The core 1190 may be a reduced instruction set architecture computing (RISC) core, a complex instruction set architecture computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front-end unit circuitry 1130 may include branch prediction circuitry 1132 coupled to instruction cache circuitry 1134, which is coupled to an instruction translation lookaside buffer (TLB) 1136, which is coupled to instruction fetch circuitry 1138, which is coupled to decode circuitry 1140. In one example, the instruction cache circuitry 1134 is included in the memory unit circuitry 1170 rather than the front-end circuitry 1130. The decode circuitry 1140 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1140 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1140 may be implemented using various different mechanisms. Examples of suitable mechanisms include, but are not limited to, look-up tables, hardware implementations, programmable logic arrays (PLAs), microcode read only memories (ROMs), etc. In one example, the core 1190 includes a microcode ROM (not shown) or other medium that stores microcode for certain macroinstructions (e.g., in decode circuitry 1140 or otherwise within the front-end circuitry 1130). In one example, the decode circuitry 1140 includes a micro-operation (micro-op) or operation cache (not shown) to hold/cache decoded operations, micro-tags, or micro-operations generated during the decode or other stages of the processor pipeline 1100. The decode circuitry 1140 may be coupled to rename/allocator unit circuitry 1152 in the execution engine circuitry 1150.

The execution engine circuitry 1150 includes the rename/allocator unit circuitry 1152 coupled to retirement unit circuitry 1154 and a set of one or more scheduler(s) circuitry 1156. The scheduler(s) circuitry 1156 represents any number of different schedulers, including reservations stations, central instruction window, etc. In some examples, the scheduler(s) circuitry 1156 can include arithmetic logic unit (ALU) scheduler/scheduling circuitry, ALU queues, address generation unit (AGU) scheduler/scheduling circuitry, AGU queues, etc. The scheduler(s) circuitry 1156 is coupled to the physical register file(s) circuitry 1158. Each of the physical register file(s) circuitry 1158 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1158 includes vector registers unit circuitry, writemask registers unit circuitry, and scalar register unit circuitry. These register units may provide architectural vector registers, vector mask registers, general-purpose registers, etc. The physical register file(s) circuitry 1158 is coupled to the retirement unit circuitry 1154 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1154 and the physical register file(s) circuitry 1158 are coupled to the execution cluster(s) 1160. The execution cluster(s) 1160 includes a set of one or more execution unit(s) circuitry 1162 and a set of one or more memory access circuitry 1164. The execution unit(s) circuitry 1162 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1156, physical register file(s) circuitry 1158, and execution cluster(s) 1160 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1164). It should also be understood that where separate pipelines are used, one or more of these pipelines may be out-of-order issue/execution and the rest in-order.

In some examples, the execution engine unit circuitry 1150 may perform load store unit (LSU) address/data pipelining to an Advanced Microcontroller Bus (AMB) interface (not shown), and address phase and writeback, data phase load, store, and branches.

The set of memory access circuitry 1164 is coupled to the memory unit circuitry 1170, which includes data TLB circuitry 1172 coupled to data cache circuitry 1174 coupled to level 2 (L2) cache circuitry 1176. In one example, the memory access circuitry 1164 may include load unit circuitry, store address unit circuitry, and store data unit circuitry, each of which is coupled to the data TLB circuitry 1172 in the memory unit circuitry 1170. The instruction cache circuitry 1134 is further coupled to the level 2 (L2) cache circuitry 1176 in the memory unit circuitry 1170. In one example, the instruction cache 1134 and the data cache 1174 are combined into a single instruction and data cache (not shown) in L2 cache circuitry 1176, level 3 (L3) cache circuitry (not shown), and/or main memory. The L2 cache circuitry 1176 is coupled to one or more other levels of cache and eventually to a main memory.

The core 1190 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1190 includes logic to support a packed data instruction set architecture extension (e.g., AVX1, AVX2), thereby allowing the operations used by many multimedia applications to be performed using packed data.

### Example Execution Unit(s) Circuitry.

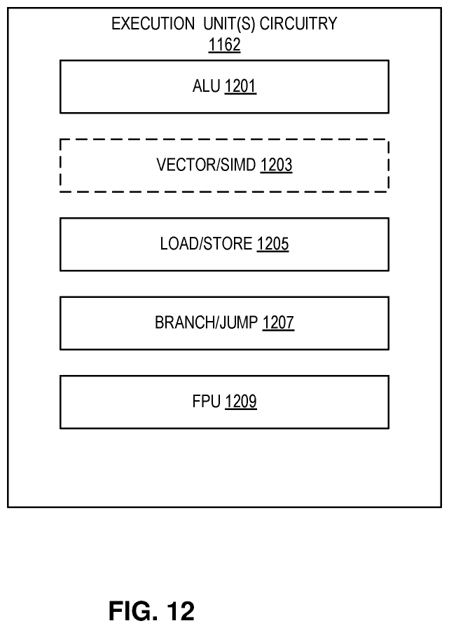

FIG. 12 illustrates examples of execution unit(s) circuitry, such as execution unit(s) circuitry 1162 of FIG. 11(B). As illustrated, execution unit(s) circuitry 1162 may include one or more ALU circuits 1201, optional vector/single instruction multiple data (SIMD) circuits 1203, load/store circuits 1205, branch/jump circuits 1207, and/or Floating-point unit (FPU) circuits 1209. ALU circuits 1201 perform integer arithmetic and/or Boolean operations. Vector/SIMD circuits 1203 perform vector/SIMD operations on packed data (such as SIMD/vector registers). Load/store circuits 1205 execute load and store instructions to load data from memory into registers or store from registers to memory. Load/store circuits 1205 may also generate addresses. Branch/jump circuits 1207 cause a branch or jump to a memory address depending on the instruction. FPU circuits 1209 perform floating-point arithmetic. The width of the execution unit(s) circuitry 1162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

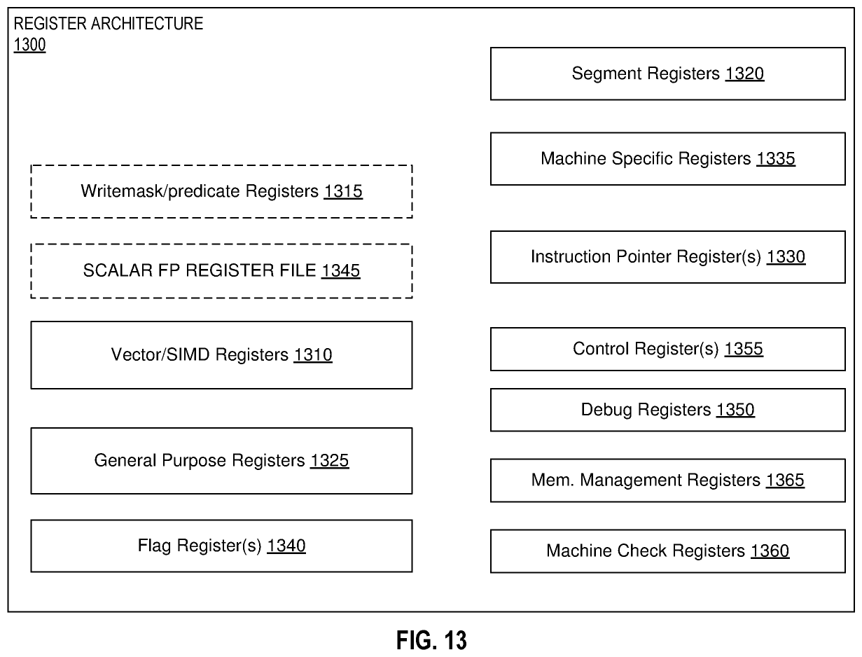

FIG. 13 is a block diagram of a register architecture 1300 according to some examples. As illustrated, the register architecture 1300 includes vector/SIMD registers 1310 that vary from 128-bit to 1,024 bits width. In some examples, the vector/SIMD registers 1310 are physically 512-bits and, depending upon the mapping, only some of the lower bits are used. For example, in some examples, the vector/SIMD registers 1310 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1300 includes writemask/predicate registers 1315. For example, in some examples, there are 8 writemask/predicate registers (sometimes called k0 through k7) that are each 16-bit, 32-bit, 64-bit, or 128-bit in size. Writemask/predicate registers 1315 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1315 corresponds to a data element position of the destination. In other examples, the writemask/predicate registers 1315 are scalable and consists of a set number of enable bits for a given vector element (e.g., 8 enable bits per 64-bit vector element).

The register architecture 1300 includes a plurality of general-purpose registers 1325. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1300 includes scalar floating-point (FP) register file 1345 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1340 (e.g., EFLAGS, RFLAGS, etc.) store status and control information for arithmetic, compare, and system operations. For example, the one or more flag registers 1340 may store condition code information such as carry, parity, auxiliary carry, zero, sign, and overflow. In some examples, the one or more flag registers 1340 are called program status and control registers.

Segment registers 1320 contain segment points for use in accessing memory. In some examples, these registers are referenced by the names CS, DS, SS, ES, FS, and GS.

Machine specific registers (MSRs) 1335 control and report on processor performance. Most MSRs 1335 handle system-related functions and are not accessible to an application program. Machine check registers 1360 consist of control, status, and error reporting MSRs that are used to detect and report on hardware errors.

One or more instruction pointer register(s) 1330 store an instruction pointer value. Control register(s) 1355 (e.g., CR0-CR4) determine the operating mode of a processor (e.g., processor 970, 980, 938, 915, and/or 1000) and the characteristics of a currently executing task. Debug registers 1350 control and allow for the monitoring of a processor or core's debugging operations.

Memory (mem) management registers 1365 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1300 may, for example, be used in register file/memory ‘ISAB08, or physical register file(s) circuitry 1158.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

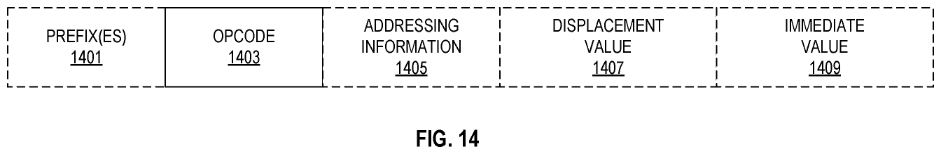

FIG. 14 illustrates examples of an instruction format. As illustrated, an instruction may include multiple components including, but not limited to, one or more fields for: one or more prefixes 1401, an opcode 1403, addressing information 1405 (e.g., register identifiers, memory addressing information, etc.), a displacement value 1407, and/or an immediate value 1409. Note that some instructions utilize some or all the fields of the format whereas others may only use the field for the opcode 1403. In some examples, the order illustrated is the order in which these fields are to be encoded, however, it should be appreciated that in other examples these fields may be encoded in a different order, combined, etc.

The prefix(es) field(s) 1401, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1403 is used to at least partially define the operation to be performed upon a decoding of the instruction. In some examples, a primary opcode encoded in the opcode field 1403 is one, two, or three bytes in length. In other examples, a primary opcode can be a different length. An additional 3-bit opcode field is sometimes encoded in another field.

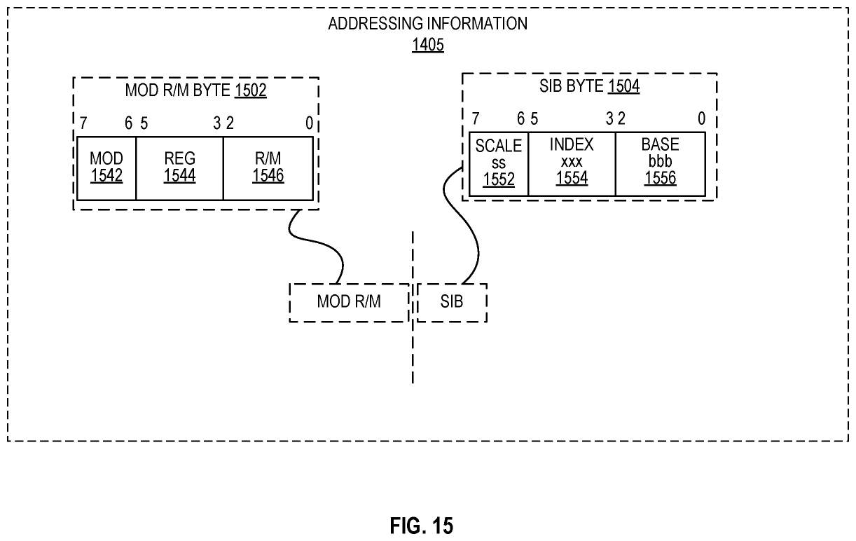

The addressing information field 1405 is used to address one or more operands of the instruction, such as a location in memory or one or more registers. FIG. 15 illustrates examples of the addressing information field 1405. In this illustration, an optional MOD R/M byte 1502 and an optional Scale, Index, Base (SIB) byte 1504 are shown. The MOD R/M byte 1502 and the SIB byte 1504 are used to encode up to two operands of an instruction, each of which is a direct register or effective memory address. Note that both of these fields are optional in that not all instructions include one or more of these fields. The MOD R/M byte 1502 includes a MOD field 1542, a register (reg) field 1544, and R/M field 1546.

The content of the MOD field 1542 distinguishes between memory access and non-memory access modes. In some examples, when the MOD field 1542 has a binary value of 11 (11b), a register-direct addressing mode is utilized, and otherwise a register-indirect addressing mode is used.

The register field 1544 may encode either the destination register operand or a source register operand or may encode an opcode extension and not be used to encode any instruction operand. The content of register field 1544, directly or through address generation, specifies the locations of a source or destination operand (either in a register or in memory). In some examples, the register field 1544 is supplemented with an additional bit from a prefix (e.g., prefix 1401) to allow for greater addressing.

The R/M field 1546 may be used to encode an instruction operand that references a memory address or may be used to encode either the destination register operand or a source register operand. Note the R/M field 1546 may be combined with the MOD field 1542 to dictate an addressing mode in some examples.

The SIB byte 1504 includes a scale field 1552, an index field 1554, and a base field 1556 to be used in the generation of an address. The scale field 1552 indicates a scaling factor. The index field 1554 specifies an index register to use. In some examples, the index field 1554 is supplemented with an additional bit from a prefix (e.g., prefix 1401) to allow for greater addressing. The base field 1556 specifies a base register to use. In some examples, the base field 1556 is supplemented with an additional bit from a prefix (e.g., prefix 1401) to allow for greater addressing. In practice, the content of the scale field 1552 allows for the scaling of the content of the index field 1554 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1407 provides this value. Additionally, in some examples, a displacement factor usage is encoded in the MOD field of the addressing information field 1405 that indicates a compressed displacement scheme for which a displacement value is calculated and stored in the displacement field 1407.

In some examples, the immediate value field 1409 specifies an immediate value for the instruction. An immediate value may be encoded as a 1-byte value, a 2-byte value, a 4-byte value, etc.

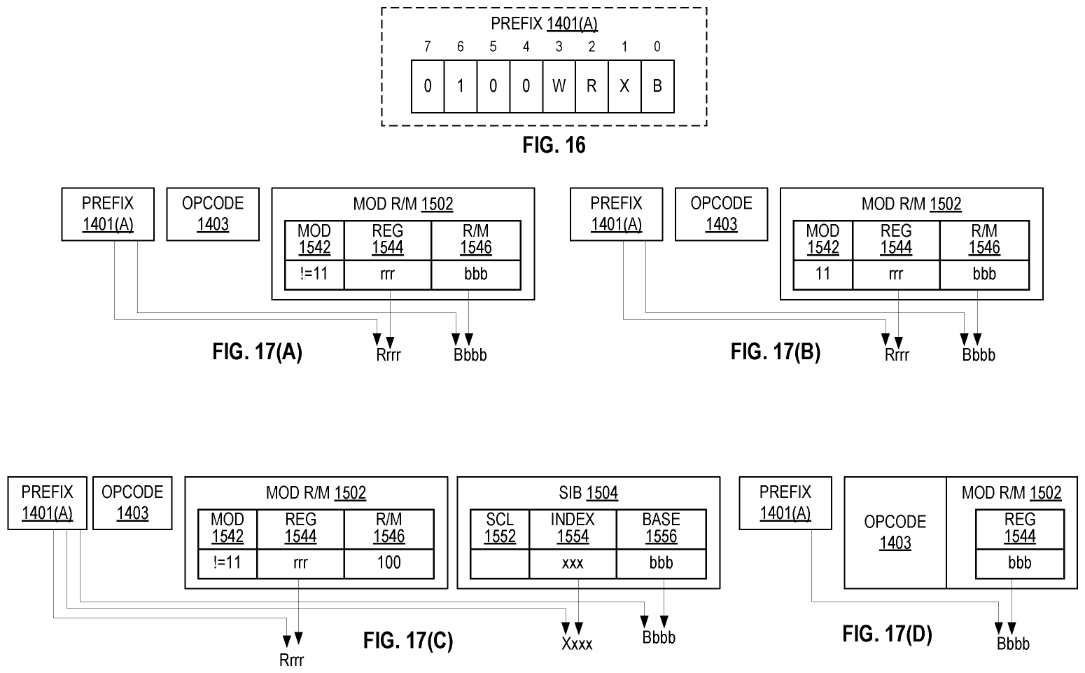

FIG. 16 illustrates examples of a first prefix 1401(A). In some examples, the first prefix 1401(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1401(A) may specify up to three registers using 3-bit fields depending on the format: 1) using the reg field 1544 and the R/M field 1546 of the MOD R/M byte 1502; 2) using the MOD R/M byte 1502 with the SIB byte 1504 including using the reg field 1544 and the base field 1556 and index field 1554; or 3) using the register field of an opcode.

In the first prefix 1401(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1544 and MOD R/M R/M field 1546 alone can each only address 8 registers.

In the first prefix 1401(A), bit position 2 (R) may be an extension of the MOD R/M reg field 1544 and may be used to modify the MOD R/M reg field 1544 when that field encodes a general-purpose register, a 64-bit packed data register (e.g., a SSE register), or a control or debug register. R is ignored when MOD R/M byte 1502 specifies other registers or defines an extended opcode.

Bit position 1 (X) may modify the SIB byte index field 1554.

Bit position 0 (B) may modify the base in the MOD R/M R/M field 1546 or the SIB byte base field 1556; or it may modify the opcode register field used for accessing general purpose registers (e.g., general purpose registers 1325).

FIGS. 17(A)-(D) illustrate examples of how the R, X, and B fields of the first prefix 1401(A) are used. FIG. 17(A) illustrates R and B from the first prefix 1401(A) being used to extend the reg field 1544 and R/M field 1546 of the MOD R/M byte 1502 when the SIB byte 1504 is not used for memory addressing. FIG. 17(B) illustrates R and B from the first prefix 1401(A) being used to extend the reg field 1544 and R/M field 1546 of the MOD R/M byte 1502 when the SIB byte 1504 is not used (register-register addressing). FIG. 17(C) illustrates R, X, and B from the first prefix 1401(A) being used to extend the reg field 1544 of the MOD R/M byte 1502 and the index field 1554 and base field 1556 when the SIB byte 1504 being used for memory addressing. FIG. 17(D) illustrates B from the first prefix 1401(A) being used to extend the reg field 1544 of the MOD R/M byte 1502 when a register is encoded in the opcode 1403.

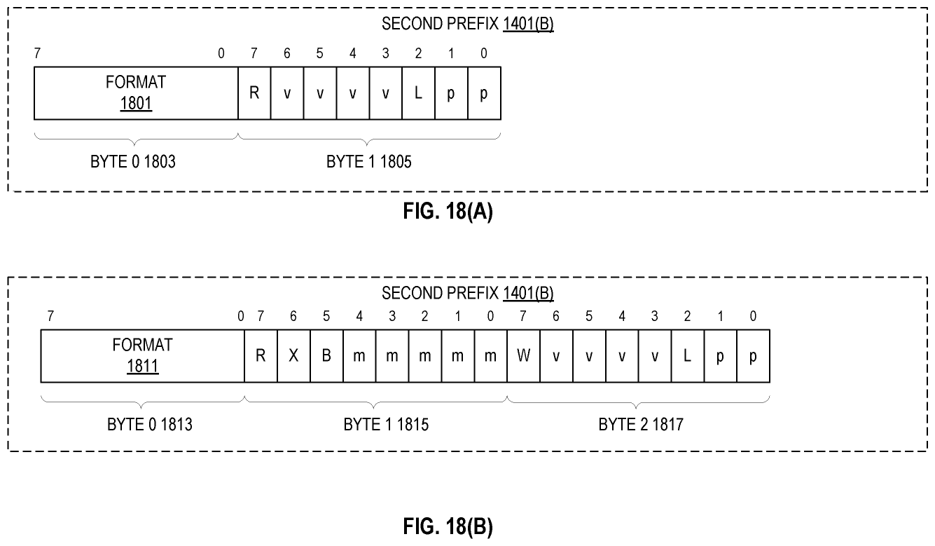

FIGS. 18(A)-(B) illustrate examples of a second prefix 1401(B). In some examples, the second prefix 1401(B) is an example of a VEX prefix. The second prefix 1401(B) encoding allows instructions to have more than two operands, and allows SIMD vector registers (e.g., vector/SIMD registers 1310) to be longer than 64-bits (e.g., 128-bit and 256-bit). The use of the second prefix 1401(B) provides for three-operand (or more) syntax. For example, previous two-operand instructions performed operations such as A=A+B, which overwrites a source operand. The use of the second prefix 1401(B) enables operands to perform nondestructive operations such as A=B+C.

In some examples, the second prefix 1401(B) comes in two forms—a two-byte form and a three-byte form. The two-byte second prefix 1401(B) is used mainly for 128-bit, scalar, and some 256-bit instructions; while the three-byte second prefix 1401(B) provides a compact replacement of the first prefix 1401(A) and 3-byte opcode instructions.

FIG. 18(A) illustrates examples of a two-byte form of the second prefix 1401(B). In one example, a format field 1801 (byte 0 1803) contains the value C5H. In one example, byte 1 1805 includes an “R” value in bit [7]. This value is the complement of the “R” value of the first prefix 1401(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1546 to encode the instruction operand that references a memory address or encode either the destination register operand or a source register operand.

Instructions that use this prefix may use the MOD R/M reg field 1544 to encode either the destination register operand or a source register operand, or to be treated as an opcode extension and not used to encode any instruction operand.

For instruction syntax that support four operands, vvvv, the MOD R/M R/M field 1546 and the MOD R/M reg field 1544 encode three of the four operands. Bits [7:4] of the immediate value field 1409 are then used to encode the third source register operand.

FIG. 18(B) illustrates examples of a three-byte form of the second prefix 1401(B). In one example, a format field 1811 (byte 0 1813) contains the value C4H. Byte 1 1815 includes in bits [7:5] “R,” “X,” and “B” which are the complements of the same values of the first prefix 1401(A). Bits [4:0] of byte 1 1815 (shown as mmmmm) include content to encode, as need, one or more implied leading opcode bytes. For example, 00001 implies a OFH leading opcode, 00010 implies a 0F38H leading opcode, 00011 implies a 0F3AH leading opcode, etc.

Bit [7] of byte 2 1817 is used similar to W of the first prefix 1401(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 1546 to encode the instruction operand that references a memory address or encode either the destination register operand or a source register operand.

Instructions that use this prefix may use the MOD R/M reg field 1544 to encode either the destination register operand or a source register operand, or to be treated as an opcode extension and not used to encode any instruction operand.

For instruction syntax that support four operands, vvvv, the MOD R/M R/M field 1546, and the MOD R/M reg field 1544 encode three of the four operands. Bits [7:4] of the immediate value field 1409 are then used to encode the third source register operand.

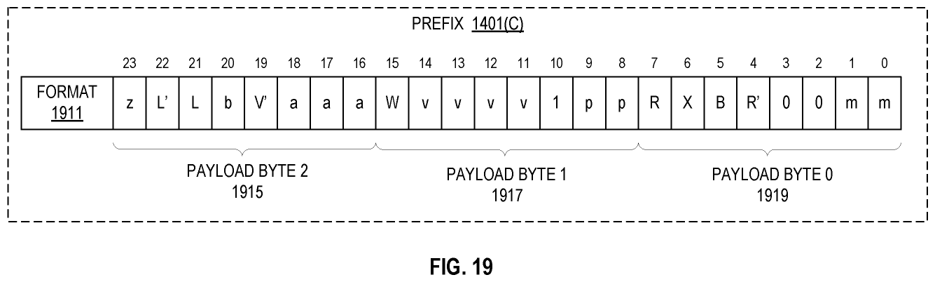

FIG. 19 illustrates examples of a third prefix 1401(C). In some examples, the third prefix 1401(C) is an example of an EVEX prefix. The third prefix 1401(C) is a four-byte prefix.

The third prefix 1401(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 13) or predication utilize this prefix. Opmask register allow for conditional processing or selection control. Opmask instructions, whose source/destination operands are opmask registers and treat the content of an opmask register as a single value, are encoded using the second prefix 1401(B).

The third prefix 1401(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1401(C) is a format field 1911 that has a value, in one example, of 62H. Subsequent bytes are referred to as payload bytes 1915-1919 and collectively form a 24-bit value of P[23:0] providing specific capability in the form of one or more fields (detailed herein).

In some examples, P[1:0] of payload byte 1919 are identical to the low two mm bits. P[3:2] are reserved in some examples. Bit P[4] (R′) allows access to the high 16 vector register set when combined with P[7] and the MOD R/M reg field 1544. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1544 and MOD R/M R/M field 1546. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

P[15] is similar to W of the first prefix 1401(A) and second prefix 1411(B) and may serve as an opcode extension bit or operand size promotion.

P[18:16] specify the index of a register in the opmask (writemask) registers (e.g., writemask/predicate registers 1315). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1401(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or Destination |
| RM | X | B | MOD R/M | GPR, Vector | 1st Source or Destination |
| | | | R/M | | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

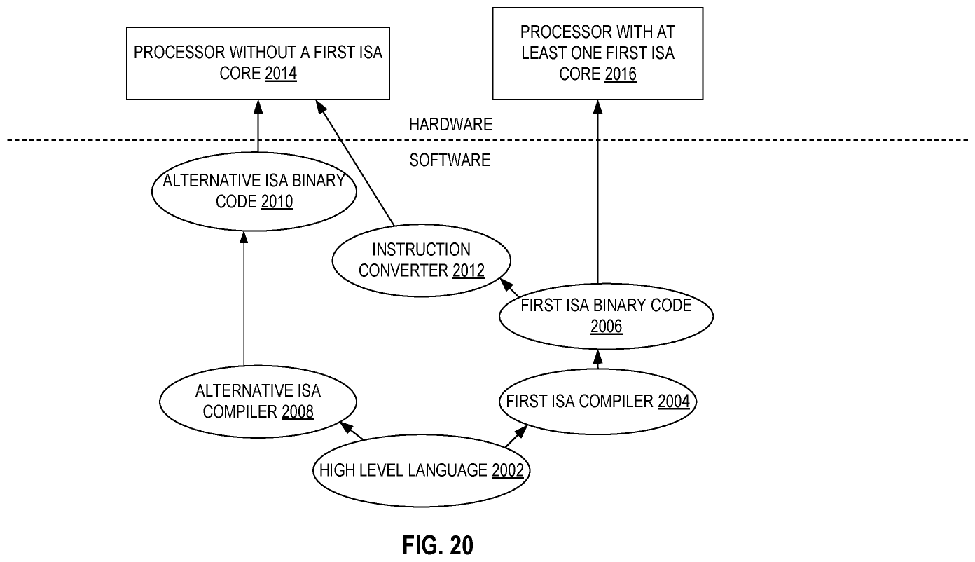

FIG. 20 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 20 shows a program in a high-level language 2002 may be compiled using a first ISA compiler 2004 to generate first ISA binary code 2006 that may be natively executed by a processor with at least one first ISA core 2016. The processor with at least one first ISA core 2016 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2004 represents a compiler that is operable to generate first ISA binary code 2006 (e.g., object code) that can, with or without additional linkage processing, be executed on the processor with at least one first ISA core 2016. Similarly, FIG. 20 shows the program in the high-level language 2002 may be compiled using an alternative ISA compiler 2008 to generate alternative ISA binary code 2010 that may be natively executed by a processor without a first ISA core 2014. The instruction converter 2012 is used to convert the first ISA binary code 2006 into code that may be natively executed by the processor without a first ISA core 2014. This converted code is not necessarily to be the same as the alternative ISA binary code 2010; however, the converted code will accomplish the general operation and be made up of instructions from the alternative ISA. Thus, the instruction converter 2012 represents software, firmware, hardware, or a combination thereof that, through emulation, simulation or any other process, allows a processor or other electronic device that does not have a first ISA processor or core to execute the first ISA binary code 2006.

Components, features, and details described for any of FIGS. 5-8 may also optionally apply to any of FIGS. 3-4. Components, features, and details described for any of the circuits or apparatus disclosed herein (e.g., digital signature verification unit 308, digital signature verification unit 508) may optionally apply to any of the methods disclosed herein, which in embodiments may optionally be performed by and/or with such processors. Any of the digital signature verification unit described herein (e.g., digital signature verification unit 308, digital signature verification unit 508) in embodiments may optionally be included in any of the systems disclosed herein (e.g., any of the systems of FIGS. 9-10).

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Circuitry or apparatus disclosed herein may be said and/or claimed to be operative, operable, capable, able, configured adapted, or otherwise to perform an operation. As used herein, these expressions refer to the characteristics, properties, or attributes of the circuitry or apparatus when in a powered-off state, and do not imply that the circuitry or apparatus or the device or apparatus in which they are included is currently powered on or operating. For clarity, it is to be understood that the circuitry and apparatus claimed herein are not claimed as being powered on or running.

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other. For example, a multi-scheme hash-based digital signature verification unit may optionally be coupled with shared cryptographic hash circuitry via one one or more intervening components (e.g., a memory, buffer, etc.). In the FIGs., arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth in order to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail in order to avoid obscuring the understanding of the description.

### EXAMPLE EMBODIMENTS

The following examples pertain to further embodiments. Specifics in the examples may be used anywhere in one or more embodiments.

Example 1 is an apparatus including cryptographic hash circuitry to generate cryptographic hashes and multi-scheme hash-based digital signature verification circuitry coupled with the cryptographic hash circuitry. The multi-scheme hash-based digital signature verification circuitry is to alternatingly use the cryptographic hash circuitry to verify digital signatures according to only one of a plurality of hash-based digital signature verification schemes at a time. The plurality of hash-based digital signature verification schemes including a first hash-based digital signature verification scheme and a second hash-based digital signature verification scheme.

Example 2 includes the apparatus of Example 1, where the multi-scheme hash-based digital signature verification circuitry includes first scheme circuitry and second scheme circuitry. The first scheme circuitry is to use the cryptographic hash circuitry to verify the digital signatures according to the first hash-based digital signature verification scheme. The second scheme circuitry is to use the cryptographic hash circuitry to verify the digital signatures according to the second hash-based digital signature verification scheme.

Example 3 includes the apparatus of Example 2, where the cryptographic hash circuitry is to be shared by the first scheme circuitry and the second scheme circuitry.

Example 4 includes the apparatus of any one of Examples 1 to 3, optionally where the first hash-based digital signature verification scheme is either eXtended Merkle Signature Scheme (XMSS) or multi-tree XMSS (XMSSMT), and optionally where the second hash-based digital signature verification scheme is either Leighton-Micali Signatures (LMS) or Hierarchical Signature System (HSS).

Example 5 includes the apparatus of any one of Examples 1 to 4, where the first hash-based digital signature verification scheme is an extended Merkle Signature Scheme (XMSS) based scheme.

Example 6 includes the apparatus of any one of Examples 1 to 5, where the second hash-based digital signature verification scheme is a Leighton-Micali Signatures (LMS) based scheme.

Example 7 includes the apparatus of any one of Examples 1 to 6, further including a memory coupled with the multi-scheme hash-based digital signature verification circuitry, the memory to store data for digital signatures being verified according to either one of the first and second hash-based digital signature verification schemes.

Example 8 includes the apparatus of Example 7, where the memory is coupled with the multi-scheme hash-based digital signature verification circuitry by one or more read or write ports each having a width of at least 64-bits.

Example 9 includes the apparatus of Example 8, where the one or more read or write ports each have a width of at least 128-bits.

Example 10 includes the apparatus of any one of Examples 1 to 9, where the apparatus is to output an indication of at least four bits to indicate whether a digital signature verification has passed or failed.

Example 11 includes the apparatus of Example 10, where the indication has at least 128-bits.

Example 12 includes the apparatus of any one of Examples 1 to 11, where the cryptographic hash circuitry includes at least one selected from a group consisting of SHA-2 circuitry, SHA-3 circuitry, SHAKE circuitry, and BLAKE circuitry.

Example 13 is a system including a processor including cryptographic hash circuitry to generate cryptographic hashes and multi-scheme hash-based digital signature verification circuitry coupled with the cryptographic hash circuitry. The multi-scheme hash-based digital signature verification circuitry is to alternatingly use the cryptographic hash circuitry to verify digital signatures according to only either one of a plurality of hash-based digital signature verification schemes at a time. The plurality of hash-based digital signature verification schemes including a first hash-based digital signature verification scheme and a second hash-based digital signature verification scheme. The system also includes a dynamic random access memory (DRAM) coupled with the processor.

Example 14 includes the system of Example 13, where the multi-scheme hash-based digital signature verification circuitry includes first scheme circuitry and second scheme circuitry. The first scheme circuitry is to use the cryptographic hash circuitry to verify the digital signatures according to the first hash-based digital signature verification scheme. The second scheme circuitry to use the cryptographic hash circuitry to verify the digital signatures according to the second hash-based digital signature verification scheme. Also optionally where the cryptographic hash circuitry is to be shared by the first scheme circuitry and the second scheme circuitry.

Example 15 includes the system of any one of Examples 13 to 14, optionally where the first hash-based digital signature verification scheme is either eXtended Merkle Signature Scheme (XMSS) or multi-tree XMSS (XMSSMT), optionally where the second hash-based digital signature verification scheme is either Leighton-Micali Signatures (LMS) or Hierarchical Signature System (HSS), and optionally where the cryptographic hash circuitry includes at least one selected from a group consisting of SHA-2 circuitry, SHA-3 circuitry, SHAKE circuitry, and BLAKE circuitry.

Example 16 includes the system of any one of Examples 13 to 15, further including a memory coupled with the multi-scheme hash-based digital signature verification circuitry, the memory to store data for digital signatures being verified according to either one of the first and second hash-based digital signature verification schemes, and optionally where the memory is coupled with the multi-scheme hash-based digital signature verification circuitry by one or more read or write ports each having a width of at least 128-bits.

Example 17 is a method including generating cryptographic hashes with a cryptographic hash circuitry, and alternatingly using the cryptographic hash circuitry to verify digital signatures according to only either one of a plurality of hash-based digital signature verification schemes at a time. The plurality of hash-based digital signature verification schemes including a first hash-based digital signature verification scheme and a second hash-based digital signature verification scheme.

Example 18 includes the method of Example 17, further including sharing the cryptographic hash circuitry when verifying digital signatures for each of the first and second hash-based digital signature verification schemes.

Example 19 includes the method of any one of Examples 17 to 18, optionally where the first hash-based digital signature verification scheme is either eXtended Merkle Signature Scheme (XMSS) or multi-tree XMSS (XMSSMT), optionally where the second hash-based digital signature verification scheme is either Leighton-Micali Signatures (LMS) or Hierarchical Signature System (HSS), and optionally where generating the cryptographic hashes includes generating either SHA-2 hashes or SHA-3 hashes.

Example 20 includes the method of any one of Examples 17 to 19, further including storing data associated with digital signatures verified according to either one of the first and second hash-based digital signature verification schemes in a memory that is shared by each of the first and second hash-based digital signature verification schemes.

Example 21 is an apparatus including first means for generating cryptographic hashes and second means coupled with the first means. The second means for alternatingly using the cryptographic hash circuitry to verify digital signatures according to only one of a plurality of hash-based digital signature verification schemes at a time. The plurality of hash-based digital signature verification schemes including a first hash-based digital signature verification scheme and a second hash-based digital signature verification scheme.

Example 22 is an apparatus including means for performing the method of any one of examples 17-20.

What is claimed is:

1. An apparatus comprising:
cryptographic hash circuitry to generate cryptographic hashes; and
multi-scheme hash-based digital signature verification circuitry coupled with the cryptographic hash circuitry, the multi-scheme hash-based digital signature verification circuitry to use the cryptographic hash circuitry to verify digital signatures according to only one of a plurality of hash-based digital signature verification schemes at a time, the plurality of hash-based digital signature verification schemes including a first hash-based digital signature verification scheme and a second hash-based digital signature verification scheme.

2. The apparatus of claim 1, wherein the multi-scheme hash-based digital signature verification circuitry comprises:
first scheme circuitry to use the cryptographic hash circuitry to verify the digital signatures according to the first hash-based digital signature verification scheme; and
second scheme circuitry to use the cryptographic hash circuitry to verify the digital signatures according to the second hash-based digital signature verification scheme.

3. The apparatus of claim 2, wherein the cryptographic hash circuitry is to be shared by the first scheme circuitry and the second scheme circuitry, and wherein the first scheme circuitry and the second scheme circuitry are to alternatingly use the cryptographic hash circuitry.

4. The apparatus of claim 3, wherein the first hash-based digital signature verification scheme is either eXtended Merkle Signature Scheme (XMSS) or multi-tree XMSS (XMSSMT), and wherein the second hash-based digital signature verification scheme is either Leighton-Micali Signatures (LMS) or Hierarchical Signature System (HSS).

5. The apparatus of claim 1, wherein the first hash-based digital signature verification scheme is an extended Merkle Signature Scheme (XMSS) based scheme.

6. The apparatus of claim 5, wherein the second hash-based digital signature verification scheme is a Leighton-Micali Signatures (LMS) based scheme.

7. The apparatus of claim 1, further comprising a memory coupled with the multi-scheme hash-based digital signature verification circuitry, the memory to store data for digital signatures being verified according to either one of the first and second hash-based digital signature verification schemes.

8. The apparatus of claim 7, wherein the memory is coupled with the multi-scheme hash-based digital signature verification circuitry by one or more read or write ports each having a width of at least 64-bits.

9. The apparatus of claim 8, wherein the one or more read or write ports each have a width of at least 128-bits.

10. The apparatus of claim 1, wherein the apparatus is to output an indication of at least four bits to indicate whether a digital signature verification has passed or failed.

11. The apparatus of claim 10, wherein the indication has at least 128-bits.

12. The apparatus of claim 11, wherein the cryptographic hash circuitry comprises at least one selected from a group consisting of SHA-2 circuitry, SHA-3 circuitry, SHAKE circuitry, and BLAKE circuitry.

13. A system comprising:
a processor comprising:
cryptographic hash circuitry to generate cryptographic hashes; and
multi-scheme hash-based digital signature verification circuitry coupled with the cryptographic hash circuitry, the multi-scheme hash-based digital signature verification circuitry to use the cryptographic hash circuitry to verify digital signatures according to only either one of a plurality of hash-based digital signature verification schemes at a time, the plurality of hash-based digital signature verification schemes including a first hash-based digital signature verification scheme and a second hash-based digital signature verification scheme; and
a dynamic random access memory (DRAM) coupled with the processor.

14. The system of claim 13, wherein the multi-scheme hash-based digital signature verification circuitry comprises:
first scheme circuitry to use the cryptographic hash circuitry to verify the digital signatures according to the first hash-based digital signature verification scheme; and
second scheme circuitry to use the cryptographic hash circuitry to verify the digital signatures according to the second hash-based digital signature verification scheme, wherein the cryptographic hash circuitry is to be shared by the first scheme circuitry and the second scheme circuitry.

15. The system of claim 13, wherein the first hash-based digital signature verification scheme is either eXtended Merkle Signature Scheme (XMSS) or multi-tree XMSS (XMSSMT), wherein the second hash-based digital signature verification scheme is either Leighton-Micali Signatures (LMS) or Hierarchical Signature System (HSS), and wherein the cryptographic hash circuitry comprises at least one selected from a group consisting of SHA-2 circuitry, SHA-3 circuitry, SHAKE circuitry, and BLAKE circuitry.

16. The system of claim 13, further comprising a memory coupled with the multi-scheme hash-based digital signature verification circuitry, the memory to store data for digital signatures being verified according to either one of the first and second hash-based digital signature verification schemes, and wherein the memory is coupled with the multi-scheme hash-based digital signature verification circuitry by one or more read or write ports each having a width of at least 128-bits.

17. A method comprising:
generating cryptographic hashes with a cryptographic hash circuitry; and
using the cryptographic hash circuitry to verify digital signatures according to only either one of a plurality of hash-based digital signature verification schemes at a time, the plurality of hash-based digital signature verification schemes including a first hash-based digital signature verification scheme and a second hash-based digital signature verification scheme.

18. The method of claim 17, further comprising sharing the cryptographic hash circuitry when verifying digital signatures for each of the first and second hash-based digital signature verification schemes.

19. The method of claim 17, wherein the first hash-based digital signature verification scheme is either eXtended Merkle Signature Scheme (XMSS) or multi-tree XMSS (XMSSMT), wherein the second hash-based digital signature verification scheme is either Leighton-Micali Signatures (LMS) or Hierarchical Signature System (HSS), and wherein generating the cryptographic hashes comprises generating either SHA-2 hashes or SHA-3 hashes.

20. The method of claim 17, further comprising storing data associated with digital signatures verified according to either one of the first and second hash-based digital signature verification schemes in a memory that is shared by each of the first and second hash-based digital signature verification schemes.
